(19) United States
(12) Patent Application Publication
(10) Pub. No.: US 2010/0270020 A1
(43) Pub. Date: Oct. 28, 2010

(54) METHODS FOR TREATING HYDROCARBON-BEARING FORMATIONS WITH FLUORINATED ANIONIC SURFACTANT COMPOSITIONS

(76) Inventors: Jimmie R. Baran, Jr., Prescott, WI (US); Michael S. Terrazas, Prescott, WI (US); Rudolf J. Dams, Antwerp (BE)

Correspondence Address: 3M INNOVATIVE PROPERTIES COMPANY, PO BOX 33427, ST. PAUL, MN, 55133-3427, US

(21) Appl. No.: 12/809,615

(22) PCT Filed: Dec. 18, 2008
(86) PCT No.: PCT/US08/87337

§ 371 Date: Jun. 21, 2010

Related U.S. Application Data
(60) Provisional application No. 61/016,141, filed on Dec. 21, 2007.
(60) Provisional application No. 61/032,310, filed on Feb. 28, 2008.

(51) Int. Cl. E21B 43/16; C09K 8/68; E21B 43/00

(52) U.S. Cl. 166/305.1; 507/261; 507/266; 507/268; 507/205; 166/369

(57) ABSTRACT

Methods of treating a hydrocarbon-bearing formation having brine and liquid hydrocarbons and treated hydrocarbon-bearing formations. The methods include contacting the hydrocarbon-bearing formation with a composition comprising solvent and a fluorinated anionic surfactant. In some embodiments, the solvent solubilizes the brine in the hydrocarbon-bearing formation without causing the fluorinated anionic surfactant to precipitate. In some embodiments, the solvent includes at least one of a polyol or polyol ether independently having from 2 to 25 carbon atoms and at least one of water, a monohydroxy alcohol, an ether, or a ketone, wherein the monohydroxy alcohol, the ether, and the ketone each independently have up to 4 carbon atoms.

### BACKGROUND

In the oil and gas industry, certain surfactants (including certain fluorinated surfactants) are known as fluid additives for various downhole operations (e.g., fracturing, waterflooding, and drilling). Often, these surfactants function to decrease the surface tension of the fluid or to stabilize foamed fluids.

Some hydrocarbon and fluorochemical compounds have been used to modify the wettability of reservoir rock, which may be useful, for example, to prevent or remedy water blocking (e.g., in oil or gas wells) or liquid hydrocarbon accumulation (e.g., in gas wells) in the vicinity of the well bore (i.e., the near well bore region). Water blocking and liquid hydrocarbon accumulation may result from natural phenomena (e.g., water-bearing geological zones or condensate banking) and/or operations conducted on the well (e.g., using aqueous or hydrocarbon fluids). Water blocking and condensate banking in the near well bore region of a hydrocarbon-bearing geological formation can inhibit or stop production of hydrocarbons from the well and hence are typically not desirable. Not all hydrocarbon and fluorochemical compounds, however, provide the desired wettability modification.

Solvent injection (e.g., injection of methanol) has been used to alleviate the problems of water blocking and condensate banking in gas wells, but this method may provide only a temporary benefit, and may not be desirable under some downhole conditions.

### SUMMARY

In one aspect, the present disclosure provides a method of treating a hydrocarbon-bearing formation having brine and liquid hydrocarbons, wherein the hydrocarbon-bearing formation has a gas permeability and a temperature, the method comprising contacting the hydrocarbon-bearing formation having brine and liquid hydrocarbons with a composition comprising solvent and a fluorinated anionic surfactant, wherein the fluorinated anionic surfactant is present in an amount sufficient to increase the gas permeability of the hydrocarbon-bearing formation, and wherein the solvent solubilizes the brine in the hydrocarbon-bearing formation without causing the fluorinated anionic surfactant to precipitate. The term “fluorinated anionic surfactant” refers to a surfactant having at least one fluorinated group and at least one anionic group (an acid or an acid salt). By the term “solubilizes” the brine, it is meant that the solvent dissolves all or nearly all (e.g., at least 95% including up to 100%) of the water and the salts in the brine.

In another aspect, the present disclosure provides a method of treating a hydrocarbon-bearing formation having brine and liquid hydrocarbons, wherein the hydrocarbon-bearing formation has a gas permeability, the method comprising:

contacting the hydrocarbon-bearing formation with a composition comprising solvent and a fluorinated anionic surfactant, wherein the fluorinated anionic surfactant comprises:
a fluorinated group having an average of up to 10 fluorinated carbon atoms; and
an anionic group, wherein the anionic group is an acid or an acid salt;
   and wherein the solvent comprises:
at least one of a polyol or polyol ether independently having from 2 to 25 carbon atoms; and
at least one of water, a monohydroxy alcohol, an ether, or a ketone, wherein the monohydroxy alcohol, the ether, and the ketone each independently have up to 4 carbon atoms,

wherein after the hydrocarbon-bearing formation is contacted with the composition, the gas permeability is increased.

In some embodiments of the foregoing methods, the hydrocarbon-bearing formation is penetrated by a well bore, wherein a region near the well bore is contacted with the composition. In some of these embodiments, the method further comprises obtaining hydrocarbons from the well bore after contacting the hydrocarbon-bearing formation with the composition.

In one aspect, the present disclosure provides a hydrocarbon-bearing formation having brine treated according to a method disclosed herein. In some embodiments, the hydrocarbon-bearing formation having brine is a retrograde condensate gas reservoir penetrated by a well bore, and a region near the well bore is treated with a fluorinated anionic surfactant in an amount sufficient to increase gas permeability in the formation. In some embodiments, the hydrocarbon-bearing formation having brine is a siliciclastic formation.

Methods according to the present disclosure are typically useful, for example, for increasing the productivity of oil and/or gas wells that have brine and liquid hydrocarbons present in a near well bore region of a hydrocarbon-bearing formation. The term “productivity” as applied to a well refers to the capacity of a well to produce hydrocarbons (i.e., the ratio of the hydrocarbon flow rate to the pressure drop, where the pressure drop is the difference between the average reservoir pressure and the flowing bottom hole well pressure (i.e., flow per unit of driving force)). The brine present in the formation may be from a variety of sources including at least one of connate water, flowing water, mobile water, immobile water, residual water from a fracturing operation or from other downhole fluids, or crossflow water (e.g., water from adjacent perforated formations or adjacent layers in the formation). In some embodiments, the brine is connate water. In some embodiments, the brine causes water blocking (i.e., declining productivity resulting from increasing water saturation in a well). The liquid hydrocarbons in the hydrocarbon-bearing formation may be, for example, at least one of retrograde gas condensate or oil and may comprise, for example, at least one of methane, ethane, propane, butane, pentane, hexane, heptane, octane, nonane, decane, or higher hydrocarbons.

The methods described herein may be used in hydrocarbon-bearing formations, wherein two phases (i.e., a gas phase and an oil phase) of the hydrocarbons are present, (e.g., in gas wells having retrograde condensate and oil wells having black oil or volatile oil), resulting in an increase in permeability of at least one of gas, oil, or condensate.

Exemplary hydrocarbon-bearing formations that may be treated according to the present disclosure include siliciclastic (e.g., shale, conglomerate, diatomite, sand, and sandstone) and carbonate (e.g., limestone) formations. Typically, and surprisingly, methods according to the present invention can be used to treat siliciclastic formations. In some embodiments, the hydrocarbon-bearing formation is predominantly sandstone (i.e., at least 50 percent by weight sandstone).

In this application:

Terms such as “a”, “an” and “the” are not intended to refer to only a singular entity, but include the general class of which a specific example may be used for illustration. The terms “a”, “an”, and “the” are used interchangeably with the term “at least one”.

The phrase “comprises at least one of” followed by a list refers to comprising any one of the items in the list and any combination of two or more items in the list.

The term “brine” refers to water having at least one dissolved electrolyte salt therein (e.g., sodium chloride, calcium chloride, strontium chloride, magnesium chloride, potassium chloride, ferric chloride, ferrous chloride, and hydrates thereof) at any nonzero concentration (in some embodiments, less than 1000 parts per million by weight (ppm), or greater than 1000 ppm, greater than 10,000 ppm, greater than 20,000 ppm, 30,000 ppm, 40,000 ppm, 50,000 ppm, 100,000 ppm, 150,000 ppm, or even greater than 200,000 ppm).

The term “hydrocarbon-bearing formation” includes both hydrocarbon-bearing formations in the field (i.e., subterranean hydrocarbon-bearing formations) and portions of such hydrocarbon-bearing formations (e.g., core samples).

“Alkyl group” and the prefix “alk-” are inclusive of both straight chain and branched chain groups and of cyclic groups. Unless otherwise specified, alkyl groups herein have up to 20 carbon atoms. Cyclic groups can be monocyclic or polycyclic and, in some embodiments, have from 3 to 10 ring carbon atoms.

The term “fluoroalkyl group” includes linear, branched, and/or cyclic alkyl groups in which all C—H bonds are replaced by C—F bonds as well as groups in which hydrogen or chlorine atoms are present instead of fluorine atoms provided that up to one atom of either hydrogen or chlorine is present for every two carbon atoms. In some embodiments of perfluoroalkyl groups, when at least one hydrogen or chlorine is present, the perfluoroalkyl group includes at least one trifluoromethyl group. The term “perfluoroalkyl group” includes linear, branched, and/or cyclic alkyl groups in which all C—H bonds are replaced by C—F bonds.

The term “precipitate” means to separate from solution and remain separated under the conditions of the treatment method (i.e., in the presence of the brine and at the temperature of the hydrocarbon-bearing formation).

All numerical ranges are inclusive of their endpoints unless otherwise stated.

### BRIEF DESCRIPTION OF THE DRAWINGS

For a more complete understanding of the features and advantages of the present disclosure, reference is now made to the detailed description along with the accompanying figures and in which:

FIG. 1 is a schematic illustration of an exemplary embodiment of an offshore oil platform operating an apparatus for progressively treating a near wellbore region according to the present disclosure;

FIG. 2 is a schematic illustration of the core flood set-up used for Examples 1 to 5 and Comparative Examples A and B;

FIG. 3 is a graph depicting the pressure drop versus pore volumes for the pre- and post-treatment two-phase core flood of Example 1; and

FIG. 4 is a graph depicting the pressure drop versus pore volumes for the pre- and post-treatment two-phase core flood of Comparative Example B;

FIG. 5 is a schematic illustration of the flow set-up used for Examples 6 to 8.

### DETAILED DESCRIPTION

Methods according to the present disclosure include contacting a hydrocarbon-bearing formation with a composition comprising solvent and a fluorinated anionic surfactant. The anionic group is either an acid or an acid salt. Typical anionic groups in anionic surfactants include carboxylates, sulfates, sulfonates, phosphates, and phosphonates. In some embodiments, the fluorinated anionic surfactant comprises at least one of —P(O)(OY)₂, —O—P(O)(OY)₂, (—O)₂—P(O)(OY), —SO₃Y, —O—SO₃Y, or —CO₂Y, wherein Y is hydrogen or a counter cation. In some embodiments, Y is hydrogen. In some embodiments, Y is a counter cation. Exemplary Y counter cations include alkali metal ions (e.g., sodium, potassium, and lithium), ammonium, alkyl ammonium (e.g., dialkylammonium, trialkylammonium, and tetraalkylammonium wherein alkyl is optionally substituted by at least one hydroxyl, fluoride, or aryl group), and five to seven membered heterocyclic groups having a positively charged nitrogen atom (e.g, a pyrrolium ion, pyrazolium ion, pyrrolidinium ion, imidazolium ion, triazolium ion, isoxazolium ion, oxazolium ion, thiazolium ion, isothiazolium ion, oxadiazolium ion, oxatriazolium ion, dioxazolium ion, oxathiazolium ion, pyridinium ion, pyridazinium ion, pyrimidinium ion, pyrazinium ion, piperazinium ion, triazinium ion, oxazinium ion, piperidinium ion, oxathiazinium ion, oxadiazinium ion, and morpholinium ion, any of which may be partially or fully fluorinated). In some embodiments, Y is an alkali metal ion (e.g., sodium, potassium, and lithium). In some embodiments, Y is ammonium. In some embodiments, Y is alkylammonium wherein alkyl is optionally substituted by hydroxyl. In some embodiments, Y is diethanol ammonium.

In some embodiments of hydrocarbon-bearing formations according to the present disclosure, the formation is treated with a fluorinated anionic surfactant comprising at least one of —P(O)(OY″)₂, —O—P(O)(OY″)₂, (—O)₂—P(O)(OY″), —SO₃Y″, —O—SO₃Y″, or —CO₂Y″, wherein each Y″ is independently hydrogen, a counter cation, or a bond to the hydrocarbon-bearing formation. Suitable counter cations include the Y groups listed above. The bond to the hydrocarbon-bearing formation may be a covalent bond, an ionic bond, or a hydrogen bond.

The fluorinated group of the fluorinated anionic surfactant useful in practicing the present disclosure may be partially or fully fluorinated (i.e., perfluorinated). The fluorinated group is typically a perfluoroalkyl group or a mixture of perfluoroalkyl groups. In some embodiments, the fluorinated group has an average of up to 10, 8, 6, 4, or even up to 2 carbon atoms (e.g., in a range from 2 to 10, 2 to 8, 4 to 10, 4 to 8, 6 to 10, or 2 to 6 carbon atoms). The fluorinated group may also be a perfluoropolyether group, for example, having at least 8 perfluorinated carbon atoms and at least 2 ether linkages.

In some embodiments, fluorinated anionic surfactants useful in practicing the methods disclosed herein are small molecule surfactants (i.e., they do not have polymeric repeating units). Small molecule surfactants typically have one or two fluorinated groups, but small molecule surfactants having more fluorinated groups are possible. Small molecule surfactants typically also have one or two anionic groups, but small molecule surfactants having more anionic groups are possible. In some embodiments, the surfactant is represented by formula:

(Rf²-X—O)ₓ—P(O)—(OY)₃₋ₓ;

(Rf²-X—O)—P(O)—(OY)(O—X″—OH);

Rf²-X—SO₃Y;

Rf²-X—CO₂Y; or

Rf²-X—P(O)(OY)₂,

wherein Y is as defined above. Many fluorinated anionic surfactants of these formulas (e.g., fluorinated phosphates, fluorinated sulfonates, and fluorinated carboxylates) are commercially available. Fluorinated phosphates are available, for example, from E. I. du Pont de Nemours and Co., Wilmington, Del., under the trade designation “ZONYL FSP”, “ZONYL 9361”, “ZONYL FSE”, “ZONYL UR”, and “ZONYL 9027”. Fluorinated sulfonates are available, for example, from E. I. du Pont de Nemours and Co. under the trade designation “ZONYL FS-62”. Fluorinated carboxylates are available, for example, from E. I. du Pont de Nemours and Co. under the trade designation “ZONYL FSA”. Other fluorinated, anionic surfactants of these formulas can be prepared, for example, by known methods. For example, potassium perfluorobutanesulfonate, potassium N-(perfluorobutylsulfonyl)-N-methylglycinate (i.e., C₄F₉SO₂N(CH₃)CH₂CO₂K), and N-(perfluorohexylsulfonyl)-N-methylglycinate (i.e., C₆F₁₃SO₂N(CH₃)CH₂CO₂K) can be prepared from perfluoro-1-butanesulfonyl fluoride, which is available from Sigma-Aldrich, St. Louis, Mo., and perfluoro-1-hexanesulfonyl fluoride, respectively, using the methods described in U.S. Pat. No. 6,664,354 (Savu et al.), the disclosure of which methods are incorporated herein by reference.

In some embodiments of the hydrocarbon-bearing formations according to the present disclosure, the formation is treated with at least one of:

(Rf²-X—O)ₓ—P(O)—(OY″)₃₋ₓ;

(Rf²-X—O)—P(O)—(OY″)(O—X″—OH);

Rf²-X—SO₃Y″;

Rf²-X—CO₂Y″; or

Rf²-X—P(O)(OY″)₂,

wherein Y″ is as defined above.

In some embodiments of the methods disclosed herein, the fluorinated anionic surfactant is represented by formula:

(Rf²-X—O)ₓ—P(O)—(OY)₃₋ₓ;

(Rf²-X—O)—P(O)—(OY)(O—X″—OH);

Rf²-X—SO₃Y; or

Rf²-X—CO₂Y,

wherein Y is as defined above. In some embodiments, the fluorinated anionic surfactant is represented by formula:

(Rf²-X—O)ₓ—P(O)—(OY)₃₋ₓ;

Rf²-X—SO₃Y; or

Rf²-X—CO₂Y,

wherein Y is as defined above. In some embodiments, the surfactant is represented by formula (Rf²-X—O)ₓ—P(O)—(OY)₃₋ₓ, wherein Y is as defined above. In some of these embodiments, the surfactant is available from E. I. du Pont de Nemours and Co. under the trade designation “ZONYL 9361”.

In some embodiments of the formations disclosed herein, the formation is treated with at least one of:

(Rf²-X—O)ₓ—P(O)—(OY″)₃₋ₓ;

(Rf²-X—O)—P(O)—(OY″)(O—X″—OH);

Rf²-X—SO₃Y″; or

Rf²-X—CO₂Y″,

wherein Y″ is as defined above. In some embodiments, the surfactant is represented by formula:

(Rf²-X—O)ₓ—P(O)—(OY″)₃₋ₓ;

Rf²-X—SO₃Y″; or

Rf²-X—CO₂Y″,

wherein Y″ is as defined above. In some embodiments, the surfactant is represented by formula (Rf-X—O)ₓ—P(O)—(OY″)₃₋ₓ, wherein Y″ is as defined above.

In any of the aforementioned embodiments of the methods or formations disclosed herein wherein small molecule surfactants are used, Rf² is independently perfluoroalkyl having an average of up to 8 (in some embodiments, up to 6 or even up to 4) carbon atoms.

In any of the aforementioned embodiments, X is independently a bond, —SO₂—N(R′)(C_{y}H_{2y})—, —C(O)—N(R′)(C_{y}H_{2y})—, or alkylene that is optionally interrupted by —O— or —S—, wherein R′ is an alkyl group having up to 4 carbon atoms; and y is an integer having a value from 1 to 11. In some embodiments, X is independently —SO₂—N(R′)(C_{y}H_{2y})— or alkylene that is optionally interrupted by —O— or —S—. In some embodiments, R′ is methyl or ethyl. In some embodiments, y is 1 or 2. In some embodiments, X is —CH₂—CH₂—. In some embodiments, X is a bond.

In any of the aforementioned embodiments, X″ is alkylene that is optionally interrupted by —O— or —S— or substituted by hydroxyl. In some of these embodiments, X″ is alkylene.

In embodiments wherein (Rf²-X—O)ₓ—P(O)—(OY)₃₋ₓ or (Rf²-X—O)ₓ—P(O)—(OY″)₃₋ₓ is the surfactant, x is 1 or 2. In some embodiments, x is 1. In some embodiments, x is 2. Typically, a compound represented by formula (Rf²-X—O)ₓ—P(O)—(OY)₃₋ₓ or (Rf²-X—O)ₓ—P(O)—(OY″)₃₋ₓ is a mixture wherein x can be 1 or 2.

In some embodiments of the methods disclosed herein wherein the surfactant is represented by formula (Rf-X—O)ₓ—P(O)—(OY)₃₋ₓ, X is —CH₂—CH₂—, and Y is an alkylammonium counter cation. In some of these embodiments, Y is diethanol ammonium.

In some embodiments, the surfactant useful in practicing the methods disclosed herein and/or treating the hydrocarbon-bearing formation disclosed herein is represented by formula Rf²-SO₃Y″, wherein Rf² is perfluoroalkyl having up to 8 (e.g., up to 6, 5, or 4) carbon atoms, and Y″ is hydrogen, a counter cation, or a bond to the hydrocarbon-bearing formation. Y″ may be defined as in any of the above embodiments of Y″. In some embodiments, Y″ is potassium or calcium. In some of these embodiments, the hydrocarbon-bearing formation comprises at least one of carbonates or limestone.

In some embodiments, the surfactant useful in practicing the methods disclosed herein and/or treating the hydrocarbon-bearing formation disclosed herein is represented by formula I:

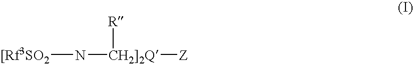

wherein Rf³ is a C₂-C₅ perfluoroalkyl group;
   R″ is a C₁-C₄ alkyl or aryl group;
   Q′ is —CHO—, —CHO(C_{z}H_{2z})—, —CHO(C_{z}H_{2z}O)ₚ(C_{z}H_{2z})—, —CHS—, —CHS(C_{z}H_{2z})—, —CHS(C_{z}H_{2z}O)_{q}(C_{z}H_{2z})— or —CHOC(O)(C_{z}H_{2z})—, in which q is an integer from 1 to 50;
   Z is —COOY″, —SO₃Y″, —N(R″)₂—(CH₂)_{z}COOY″, —N⁺(R″)₂(CH₂)_{z}SO₃Y″, —OSO₃Y″, —P(O)(OY″)², or —PO₅³⁻, in which each z is independently an integer of 1 to 10, and Y″ is hydrogen, a counter cation, or a bond to the hydrocarbon-bearing formation.
      In some of these embodiments, Rf³ is C₄F₉—. In some embodiments, R″ is CH₃— or —CH₂CH₃. R″ may also be an aryl group (e.g., phenyl) which may be unsubstituted or substituted by up to five substituents including one or more C₁-₄ alkyl (e.g., methyl or ethyl), C₁-₄ alkoxy, halo (i.e., fluoro, chloro, bromo or iodo), hydroxy, amino, or nitro groups. In some embodiments, Q′ is —CHO— or —CHOCH₂—. Y″ may be defined as in any of the above embodiments of Y″. In some embodiments, Y″ is potassium or calcium. Exemplary useful surfactants represented by formula I include (C₄F₉SO₂N(CH₃)—CH₂)₂—CHOCH₂COO⁻K⁺, (C₄F₉SO₂N(CH₃)—CH₂)₂—CHOCH₂COO⁻0.5Ca²⁺, the triethanolamine salt of (C₄F₉SO₂N(CH₃)CH₂)₂CHOPO₃H₂, and the ammonium salt of (C₄F₉SO₂N(CH₃)CH₂)₂CHOCH₂CH₂CH₂SO₃H. In some embodiments, the hydrocarbon-bearing formation comprises at least one of limestone or carbonates.

Surfactants represented by formula I can be prepared, for example, by reacting two moles of C₄F₉SO₂NH(CH)₃ with either 1,3-dichloro-2-propanol or epichlorohydrin in the presence of base to provide a hydroxyl-substituted compound represented by formula [C₄F₉SO₂N(CH)₃CH₂]₂CHOH. The hydroxyl-substituted compound can then be treated with, for example, phosphonoacetic acid, phosphonopropionic acid, phosphorous (V) oxychloride, 1,3-propanesultone, or ethyl bromoacetate followed by base to provide an anionic surfactant. The reaction with phosphonoacetic acid or phosphonopropionic acid can be carried out, for example, in a suitable solvent (e.g., methyl isobutyl ketone or methyl ethyl ketone), optionally in the presence of a catalyst (e.g., methanesulfonic acid or sodium tert-butoxide) and optionally at an elevated temperature (e.g., up to the reflux temperature of the solvent). The reaction of the hydroxyl-substituted compound with phosphorous (V) oxychloride or 1,3-propanesultone can be carried out, for example, in a suitable solvent (e.g., toluene), optionally at an elevated temperature (e.g., the reflux temperature of the solvent). If one equivalent of the hydroxyl-substituted compound is used to prepare a compound represented by formula I wherein Z is a phosphate, an equivalent of water or alcohol may be added. Further methods for preparing compounds represented by formula I may be found in the Examples of U.S. Pat. No. 7,160,850 (Dams et al.), the disclosure of which examples are incorporated herein by reference.

In some embodiments, the surfactant useful in practicing the methods disclosed herein and/or treating the hydrocarbon-bearing formation disclosed herein is a polymeric anionic surfactant comprising fluorinated repeating units. In some embodiments, the polymeric anionic surfactant has at least 2, 3, 4, 5, 10, 15, or even at least 20 fluorinated repeating units. In some embodiments, the polymeric anionic surfactant has at least 2, 3, 4, 5, 6, 7, 8, 9, or even at least 10 anionic groups. Polymeric anionic surfactants may have number average molecular weights, for example, of about 1000 grams per mole up to about 50,000, 60,000, 70,000, 80,000, 90,000 or even 100,000 grams per mole, although higher molecular weights may be useful for some polymeric compositions.

In some embodiments of the methods disclosed herein, the polymeric anionic surfactant is represented by formula:

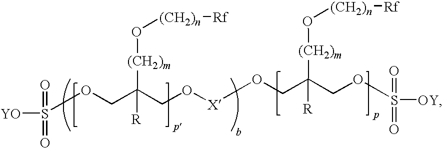

wherein Y is as defined above. Some polymeric surfactants of this formula are commercially available, for example, from Omnova Solutions Inc., Fairlawn, Ohio, under the trade designations “POLYFOX PF-156A” and “POLYFOX PF-136A”. Other polymeric surfactants of this formula can be prepared by known methods; see, e.g., U.S. Pat. No. 7,087,710 (Medsker et al.), the disclosure of which relating to methods of making anionic surfactants is incorporated herein by reference.

In some embodiments of the hydrocarbon-bearing formations disclosed herein, the polymeric anionic surfactant is represented by formula:

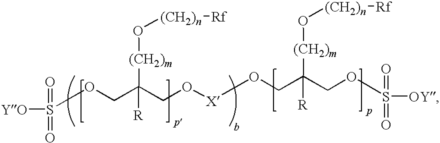

wherein Y″ is as defined above.

In the aforementioned embodiments of methods or formations disclosed herein wherein polymeric anionic surfactants are used, each Rf is independently perfluoroalkyl having up to 8, 6, 4, 3, or even up to 2 carbon atoms, and each R is independently hydrogen, alkyl having 1 to 6 carbon atoms, or —(CH₂)ₘ—O—(CH₂)ₙ-Rf. In some embodiments, each R is independently hydrogen, methyl, or ethyl. In some embodiments, each R is methyl.

In the aforementioned embodiments wherein polymeric anionic surfactants are used, each m is independently 1, 2, or 3, and each n is independently 0, 1, 2, or 3. In some embodiments, m and n are each 1.

In the aforementioned embodiments wherein polymeric anionic surfactants are used, b is 0 or 1, and when b is 1, p′ has a value from 0 to 5. p has a value from 0 to 10 (e.g., 0, 1, 2, 3, 4, 5, 6, 7, 8, 9, or 10), with the proviso that p+p′ is at least 2, 3, 4, 5, 6, 7, 8, 9, or even at least 10.

In the aforementioned embodiments wherein polymeric anionic surfactants are used, X′ is alkylene that is optionally interrupted by —O— or —S—. In some embodiments, X′ is ethoxyethylene, ethylene, propylene, butylene, or pentylene. In some embodiments, X′ is pentylene (e.g., neopentylene).

In some embodiments wherein polymeric anionic surfactants comprising fluorinated repeating units are used in the methods disclosed herein, the fluorinated repeating units are represented by formula:

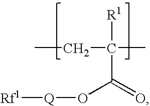

and
the polymeric surfactant further comprises at least one of

a second divalent unit represented by formula:

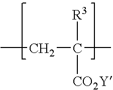

or

a monovalent unit represented by formula:

—S(CH₂)ᵣCH(R³)—CO₂Y,

wherein Y is as defined above. In some of these embodiments, the fluorinated repeating units are represented by formula:

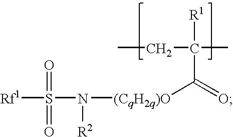

and the polymeric surfactant comprises both a second divalent unit represented by formula:

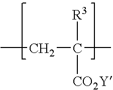

and

a monovalent unit represented by formula:

—S(CH₂)ᵣCH(R³)—CO₂Y,

wherein Y is as defined above.

In some embodiments of a hydrocarbon-bearing formation treated with a polymeric anionic surfactant comprising fluorinated repeating units, the fluorinated repeating units are represented by formula:

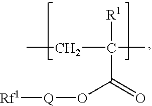

and
the polymeric surfactant further comprises at least one of

a second divalent unit represented by formula:

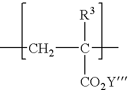

or

a monovalent unit represented by formula:

—S(CH₂)ᵣCH(R³)—CO₂Y″,

wherein Y″ is as defined above. In some of these embodiments, the fluorinated repeating units are represented by formula:

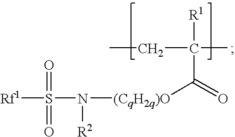

and the polymeric surfactant comprises both a second divalent unit represented by formula:

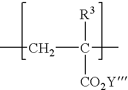

and

a monovalent unit represented by formula:

—S(CH₂)ᵣCH(R³)—CO₂Y″,

wherein Y″ is as defined above.

In any of the aforementioned formulas having an R¹ group, R¹ is independently —H or —CH₃.

In any of the aforementioned formulas having a Q group, Q is independently —SO₂—N(R²)(C_{q}H_{2q})—, —C(O)—N(R²)(C_{q}H_{2q})—, or alkylene that is optionally interrupted by —O— or —S—, wherein R² is independently an alkyl group having from 1 to 4 carbon atoms and q is independently an integer having a value from 2 to 11 (in some embodiments, 2 to 6 or even 2 to 4). In some embodiments, Q is —SO₂—N(R²)(C_{q}H_{2q})—. In some embodiments, R² is independently methyl or ethyl. In some embodiments, q is 2.

In any of the aforementioned formulas having an Rf¹ group, Rf¹ is independently perfluoroalkyl having an average of up to 8 (in some embodiments, up to 6, or even up to 4) carbon atoms. In some embodiments, Rf¹ is perfluorobutyl (e.g., perfluoro-n-butyl, perfluoro-sec-butyl, or perfluoro-isobutyl).

In any of the aforementioned formulas having an R³ group, each R³ is independently H, —CH₃, or —CH₂CO₂Y. In some embodiments, each R³ is independently hydrogen or —CH₂CO₂Y. In some embodiments, R³ is hydrogen.

For the methods disclosed herein which include polymeric anionic surfactants, Y′ is independently Y or —CH₂CH₂CO₂Y, wherein Y is hydrogen or a counter cation as defined above. In some embodiments, Y′ is Y.

For the hydrocarbon-bearing formations disclosed herein which include polymeric anionic surfactants, Y′″ is independently hydrogen, a counter cation, a bond to the hydrocarbon-bearing formation, or —CH₂CH₂CO₂Y″, wherein Y″ is as defined above. Counter cations and bonds included in the definition of Y′″ are the same as those defined for Y″, above.

In any of the aforementioned formulas having an r group, r is an integer having a value from 0 to 11 (in some embodiments, 0 to 6 or even 0 to 4). In some embodiments, r is 0.

Anionic surfactants based on acrylic polymers useful in practicing the present disclosure may be prepared, for example, by polymerizing a mixture of components typically in the presence of an initiator. By the term “polymerizing” it is meant forming a polymer or oligomer that includes at least one identifiable structural element due to each of the components. Typically the polymer or oligomer that is formed has a distribution of molecular weights and compositions. The components that are useful for preparing anionic polymeric surfactants include, for example, at least one fluorinated free-radically polymerizable monomer independently represented by formula Rf¹-Q-O—C(O)—C(R¹)═CH₂, wherein Rf¹, R¹, and Q are as defined above. In some embodiments, the components include at least one of acrylic acid, methacrylic acid, β-carboxyethyl acrylate, β-carboxyethyl methacrylate, or itaconic acid. In some embodiments, the components include at least one mercaptan-containing chain transfer agent for free-radical polymerization independently having formula HS(CH₂)ᵣCH(R³)—CO₂H, wherein r and R³ are as defined above. In some embodiments, the components include both a mercaptan-containing chain transfer agent having formula HS(CH₂)ᵣCH(R³)—CO₂H and at least one of acrylic acid, methacrylic acid, β-carboxyethyl acrylate, β-carboxyethyl methacrylate, or itaconic acid (in some embodiments, acrylic acid).

Fluorinated free-radically polymerizable monomers of formula Rf¹-Q-O—C(O)—C(R¹)═CH₂, and methods for their preparation, are known. For example, compounds of formula Rf¹-Q-O—C(O)—C(R¹)═CH₂, wherein Q is —SO₂—N(R²)(C_{q}H_{2q})— can be made according to methods described in, e.g., U.S. Pat. No. 2,803,615 (Albrecht et al.) and U.S. Pat. No. 6,664,354 (Savu et al.), the disclosures of which, relating to free-radically polymerizable monomers and methods of their preparation, are incorporated herein by reference. Some compounds of Formula Rf¹-Q-O—C(O)—C(R¹)═CH₂, wherein Q is alkylene, are available, for example, from commercial sources (e.g., 3,3,4,4,5,5,6,6,6-nonafluorohexyl acrylate from Daikin Chemical Sales, Osaka, Japan and 3,3,4,4,5,5,6,6,6-nonafluorohexyl 2-methylacrylate from Indofine Chemical Co., Hillsborough, N.J., and 2,2,3,3,4,4,5,5-octafluoropentyl acrylate and methacrylate and 3,3,4,4,5,6,6,6-octafluoro-5-(trifluoromethyl)hexyl methacrylate from Sigma-Aldrich); others can be made by know methods (see, e.g., EP1311637 B1, published Apr. 5, 2006, the disclosure of which is incorporated herein by reference for the preparation of 2,2,3,3,4,4,4-heptafluorobutyl 2-methylacrylate). Compounds of formula HS(CH₂)ᵣCH(R³)—CO₂H, acrylic acid, methacrylic acid, β-carboxyethyl acrylate, β-carboxyethyl methacrylate, itaconic acid, and/or salts thereof are available from general chemical suppliers (e.g., Sigma-Aldrich Company) or may be synthesized by conventional techniques.

Free radical initiators such as those widely known and used in the art may be used to initiate polymerization of the components. Examples of free-radical initiators include azo compounds (e.g., 2,2′-azobisisobutyronitrile (AIBN), 2,2′-azobis(2-methylbutyronitrile), or azo-2-cyanovaleric acid), hydroperoxides (e.g., cumene, tert-butyl or tert-amyl hydroperoxide), dialkyl peroxides (e.g., di-tert-butyl or dicumylperoxide), peroxyesters (e.g., tert-butyl perbenzoate or di-tert-butyl peroxyphthalate), diacylperoxides (e.g., benzoyl peroxide or lauryl peroxide). Useful photoinitiators include benzoin ethers (e.g., benzoin methyl ether or benzoin butyl ether); acetophenone derivatives (e.g., 2,2-dimethoxy-2-phenylacetophenone or 2,2-diethoxyacetophenone); and acylphosphine oxide derivatives and acylphosphonate derivatives (e.g., diphenyl-2,4,6-trimethylbenzoylphosphine oxide, isopropoxyphenyl-2,4,6-trimethylbenzoylphosphine oxide, or dimethyl pivaloylphosphonate). When heated or photolyzed such free-radical initiators fragment to generate free radicals which add to ethylenically unsaturated bonds and initiate polymerization.

Polymerization reactions may be carried out in any solvent suitable for organic free-radical polymerizations. The components may be present in the solvent at any suitable concentration, (e.g., from about 5 percent to about 90 percent by weight based on the total weight of the reaction mixture). Examples of suitable solvents include aliphatic and alicyclic hydrocarbons (e.g., hexane, heptane, cyclohexane), aromatic solvents (e.g., benzene, toluene, xylene), ethers (e.g., diethyl ether, glyme, diglyme, diisopropyl ether), esters (e.g., ethyl acetate, butyl acetate), alcohols (e.g., ethanol, isopropyl alcohol), ketones (e.g., acetone, methyl ethyl ketone, methyl isobutyl ketone), sulfoxides (e.g., dimethyl sulfoxide), amides (e.g., N,N-dimethylformamide, N,N-dimethylacetamide), halogenated solvents (e.g., methylchloroform, 1,1,2-trichloro-1,2,2-trifluoroethane, trichloroethylene or trifluorotoluene), and mixtures thereof.

Polymerization can be carried out at any temperature suitable for conducting an organic free-radical reaction. Particular temperature and solvents for use can be selected by those skilled in the art based on considerations such as, for example, the solubility of reagents, the temperature required for the use of a particular initiator, and the molecular weight desired. While it is not practical to enumerate a particular temperature suitable for all initiators and all solvents, generally suitable temperatures are in a range from about 30° C. to about 200° C.

In some embodiments of the methods and the hydrocarbon-bearing formations disclosed herein, the surfactant is a fluorinated anionic surfactant with a perfluorinated polyether group of formula: CF₃CF₂CF₂—O—[CF(CF₃)CF₂O]ₖ—CF(CF₃)—, wherein k is at least 1, 2, 3, 4, 5, 6, 7, 8, 9, or even at least 10. In some embodiments, k is 3 to 25. Anionic surfactants of this type can be prepared by oligomerization of hexafluoropropylene oxide to provide a perfluoropolyether carbonyl fluoride. The carbonyl fluoride may be converted to an acid or ester using reaction conditions well known to those skilled in the art. The resulting acid can be neutralized (e.g., with ammonium hydroxide or potassium hydroxide) to provide the fluorinated anionic surfactant.

Some carboxylic acids and carboxylic acid fluorides useful for preparing compositions according to the present invention are commercially available. For example, carboxylic acids of formula CF₃—[O—CF₂]₁₋₃C(O)OH are available, for example, from Anles Ltd., St. Petersburg, Russia, and acid fluorides of formulas C₂F₅—O—(CF₂)₂—C(O)F, C₃F₇—O—(CF₂)₂—C(O)F, and CF₃CF₂—O—CF₂CF₂—O—CF₂C(O)F are available, for example, from Exfluor, Round Rock, Tex.

In some embodiments, the fluorinated surfactant useful for practicing the methods disclosed herein is Rf⁴-CO₂Y″, wherein Rf⁴ is perfluoroalkyl having up to 6 (e.g., up to 5, 4, or 3) carbon atoms and interrupted by 1, 2, 3, 4, or 5 ether groups, and Y″ is hydrogen, a counter cation, or a bond to the hydrocarbon-bearing formation. Y″ may be defined as in any of the above embodiments of Y″. In some embodiments, Y″ is potassium or calcium. In some of these embodiments, the hydrocarbon-bearing formation comprises at least one of carbonates or limestone.

In some embodiments, the fluorinated, anionic surfactant useful for the methods disclosed herein is:

a polymeric surfactant represented by formula:

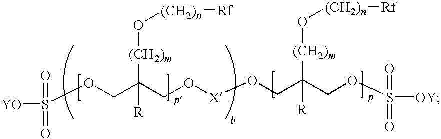

a polymeric surfactant comprising fluorinated repeating units represented by formula:

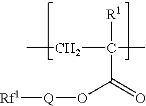

and at least one of
a second divalent unit represented by formula:

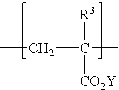

or
a monovalent unit represented by formula —S(CH₂)ᵣCH(R³)—CO₂Y;

(Rf²-X—O)ₓ—P(O)—(OY)₃₋ₓ;

(Rf²-X—O)—P(O)—(OY)(O—X″—OH);

Rf²-X—SO₃Y;

Rf²-X—CO₂Y; or

Rf²-X—P(O)(OY)₂;

wherein Rf, Rf¹, Rf², R, R¹, R², R³, R′, Q, X, X′, X″, Y, Y′, b, m, n, p, p′, r, x, and y are as defined above.

In some embodiments, the surfactant useful for the methods disclosed herein is:

a polymeric surfactant represented by formula:

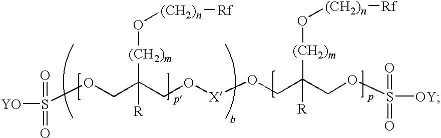

(Rf²-X—O)ₓ—P(O)—(OY)₃₋ₓ; or

(Rf²-X—O)—P(O)—(OY)(O—X″—OH);

wherein Rf, Rf², R, X, X′, X″, Y, b, m, n, p, p′, and x are as defined above.

In some embodiments of the treated hydrocarbon-bearing formations disclosed herein, the hydrocarbon-bearing formation is treated with at least one of:

a polymeric surfactant represented by formula:

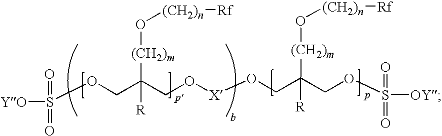

a polymeric surfactant comprising fluorinated repeating units represented by formula:

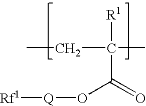

and at least one of
a second divalent unit represented by formula:

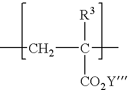

or
a monovalent unit represented by formula —S(CH₂)ᵣCH(R³)—CO₂Y″;

(Rf²-X—O)ₓ—P(O)—(OY″)₃₋ₓ;

(Rf²-X—O)—P(O)—(OY″)(O—X″—OH);

Rf²-X—SO₃Y″;

Rf²-X—CO₂Y″; or

Rf²-X—P(O)(OY″)₂;

wherein Rf, Rf¹, Rf², R, R¹, R², R³, R′, Q, X, X′, X″, Y″, Y′″, b, m, n, p, p′, q, r, x, and y are as defined above.

In some embodiments of the treated hydrocarbon-bearing formations disclosed herein, the hydrocarbon-bearing formation is treated with at least one of:

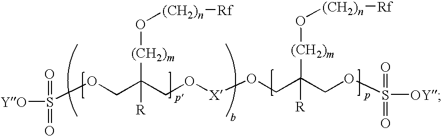

(Rf²-X—O)ₓ—P(O)—(OY″)₃₋ₓ; or

(Rf²-X—O)—P(O)—(OY″)(O—X″—OH);

wherein Rf, Rf², R, X, X′, X″, Y″, b, m, n, p, p′, q, and x are as defined above. In some of these embodiments, the hydrocarbon-bearing formation is a siliciclastic formation.

In some embodiments, surfactants useful in practicing the methods disclosed herein are free of silane groups (i.e., a group having at least one Si—O—Z moiety, wherein Z is H or substituted or unsubstituted alkyl or aryl). The absence of silane groups may be advantageous, for example, because silane groups may undergo hydrolysis and form polysiloxanes in the presence of some brines and at some temperatures when delivering the surfactant to a geological zone.

Compositions useful in practicing the methods disclosed herein comprise solvent. Examples of useful solvents include organic solvents, water, and combinations thereof. In some embodiments, the compositions comprise water and at least one organic solvent. In some embodiments, the compositions are essentially free of water (i.e., contains less than 0.1 percent by weight of water, based on the total weight of the composition). In some embodiments, the solvent is a water-miscible solvent (i.e., the solvent is soluble in water in all proportions). Examples of organic solvents include polar and/or water-miscible solvents, for example, monohydroxy alcohols having from 1 to 4 or more carbon atoms (e.g., methanol, ethanol, isopropanol, propanol, or butanol); polyols such as glycols (e.g., ethylene glycol or propylene glycol), terminal alkanediols (e.g., 1,3-propanediol, 1,4-butanediol, 1,6-hexanediol, or 1,8-octanediol), polyglycols (e.g., diethylene glycol, triethylene glycol, dipropylene glycol, or poly(propylene glycol)), triols (e.g., glycerol, trimethylolpropane), or pentaerythritol; ethers such as diethyl ether, methyl t-butyl ether, tetrahydrofuran, p-dioxane, or polyol ethers (e.g., glycol ethers (e.g., ethylene glycol monobutyl ether, diethylene glycol monomethyl ether, dipropylene glycol monomethyl ether, propylene glycol monomethyl ether, 2-butoxyethanol, or those glycol ethers available under the trade designation “DOWANOL” from Dow Chemical Co., Midland, Mich.)); ketones (e.g., acetone or 2-butanone); and combinations thereof.

In some embodiments, the solvent comprises at least one of a polyol or polyol ether independently having from 2 to 25 (in some embodiments, 2 to 15, 2 to 10, 2 to 9, or even 2 to 8) carbon atoms. In some embodiments, the solvent comprises a polyol. The term “polyol” refers to an organic molecule consisting of C, H, and O atoms connected one to another by C—H, C—C, C—O, O—H single bonds, and having at least two C—O—H groups. In some embodiments, useful polyols have 2 to 25, 2 to 20, 2 to 15, 2 to 10, 2 to 8, or even 2 to 6 carbon atoms. In some embodiments, the solvent comprises a polyol ether. The term “polyol ether” refers to an organic molecule consisting of C, H, and O atoms connected one to another by C—H, C—C, C—O, O—H single bonds, and which is at least theoretically derivable by at least partial etherification of a polyol. In some embodiments, the polyol ether has at least one C—O—H group and at least one C—O—C linkage. Useful polyol ethers may have from 3 to 25 carbon atoms, 3 to 20, 3 to 15, 3 to 10, 3 to 9, 3 to 8, or even from 5 to 8 carbon atoms. In some embodiments, the polyol is at least one of ethylene glycol, propylene glycol, poly(propylene glycol), 1,3-propanediol, or 1,8-octanediol, and the polyol ether is at least one of 2-butoxyethanol, diethylene glycol monomethyl ether, ethylene glycol monobutyl ether, dipropylene glycol monomethyl ether, or 1-methoxy-2-propanol. In some embodiments, the polyol and/or polyol ether has a normal boiling point of less than 450° F. (232° C.), which may be useful, for example, to facilitate removal of the polyol and/or polyol ether from a well after treatment.

In some embodiments, useful solvents for practicing the methods disclosed herein comprise at least one of water, a monohydroxy alcohol, an ether, or a ketone, wherein the monohydroxy alcohol, the ether, and the ketone each independently have up to 4 carbon atoms. Exemplary monohydroxy alcohols having from 1 to 4 carbon atoms include methanol, ethanol, n-propanol, isopropanol, 1-butanol, 2-butanol, isobutanol, and t-butanol. Exemplary ethers having from 2 to 4 carbon atoms include diethyl ether, ethylene glycol methyl ether, tetrahydrofuran, p-dioxane, and ethylene glycol dimethyl ether. Exemplary ketones having from 3 to 4 carbon atoms include acetone, 1-methoxy-2-propanone, and 2-butanone. In some embodiments, useful solvents for practicing the methods disclosed herein comprise at least one of methanol, ethanol, isopropanol, tetrahydrofuran, or acetone.

In some embodiments of the methods disclosed herein, the compositions comprise at least two organic solvents. In some embodiments, the compositions comprise at least one of a polyol or polyol ether independently having from 2 to 25 (in some embodiments, 2 to 15, 2 to 10, 2 to 9, or even 2 to 8) carbon atoms and at least one of water, a monohydroxy alcohol, an ether, or a ketone, wherein the monohydroxy alcohol, the ether, and the ketone each independently have up to 4 carbon atoms. In these embodiments, in the event that a component of the solvent is a member of two functional classes, it may be used as either class but not both. For example, ethylene glycol methyl ether may be a polyol ether or a monohydroxy alcohol, but not as both simultaneously. In these embodiments, each solvent component may be present as a single component or a mixture of components. In some embodiments, compositions useful for practicing the methods disclosed herein comprise at least one of a polyol or polyol ether independently having from 2 to 25 (in some embodiments, 2 to 15, 2 to 10, 2 to 9, or even 2 to 8) carbon atoms and at least one monohydroxy alcohol having up to 4 carbon atoms. In some embodiments, the solvent consists essentially of (i.e., does not contain any components that materially affect water solubilizing or displacement properties of the composition under downhole conditions) at least one of a polyol having from 2 to 25 (in some embodiments, 2 to 20, 2 to 15, 2 to 10, 2 to 9, 2 to 8, or even 2 to 6) carbon atoms or polyol ether having from 3 to 25 (in some embodiments, 3 to 20, 3 to 15, 3 to 10, 3 to 9, 3 to 8, or even from 5 to 8) carbon atoms, and at least one monohydroxy alcohol having from 1 to 4 carbon atoms, ether having from 2 to 4 carbon atoms, or ketone having from 3 to 4 carbon atoms. Typically, the solvents described herein are capable of solubilizing more brine in the presence of surfactant than methanol alone.

In some embodiments of methods according to the present disclosure, useful solvents at least one of at least partially solubilize or at least partially displace the brine in the hydrocarbon-bearing formation. In some embodiments, useful solvents at least partially solubilize or at least partially displace the liquid hydrocarbons in the hydrocarbon-bearing formation.

For any of the embodiments wherein the compositions useful for practicing the methods disclosed herein comprise at least one of a polyol or polyol ether independently having from 2 to 25 (in some embodiments, 2 to 15, 2 to 10, 2 to 9, or even 2 to 8) carbon atoms, the polyol or polyol ether is present in the composition at at least 50, 55, 60, or 65 percent by weight and up to 75, 80, 85, or 90 percent by weight, based on the total weight of the composition. In some embodiments, the solvent comprises up to 50, 40, 30, 20, or even 10 percent by weight of a monohydroxy alcohol having up to 4 carbon atoms, based on the total weight of the composition.

For any of the embodiments wherein the compositions useful for practicing the methods disclosed herein comprise at least two organic solvents, the solvents may be those, for example, shown in Table 1, below, wherein the exemplary parts by weight are based on the total weight of solvent.

TABLE 1

| | SOLVENT 2 |
|---|---|
| SOLVENT 1 | (parts by |
| (parts by weight) | weight) |
| 1,3-propanediol | isopropanol |
| (80) | (IPA) |
| | (20) |
| propylene glycol | IPA |
| (PG) | (30) |
| (70) | |
| PG (90) | IPA (10) |
| PG (80) | IPA (20) |
| ethylene glycol | ethanol (50) |
| (EG) (50) | |
| EG (70) | ethanol (30) |
| propylene glycol | ethanol (50) |
| monobutyl ether | |
| (PGBE) (50) | |
| PGBE (70) | ethanol (30) |
| dipropylene glycol | ethanol (50) |
| monomethyl ether | |
| (DPGME) | |
| (50) | |
| DPGME (70) | ethanol (30) |
| diethylene glycol | ethanol (30) |
| monomethyl ether | |
| (DEGME) (70) | |
| triethylene glycol | ethanol (50) |
| monomethyl ether | |
| (TEGME) (50) | |
| TEGME (70) | ethanol (30) |
| 1,8-octanediol (50) | ethanol (50) |
| PG (70) | tetrahydrofuran |
| | (THF) (30) |
| PG (70) | acetone (30) |
| PG (70) | methanol (30) |
| PG (60) | IPA (40) |
| 2-butoxyethanol | ethanol (20) |
| (BE) (80) | |
| BE (70) | ethanol (30) |
| BE (60) | ethanol (40) |
| PG (70) | ethanol (30) |
| EG (70) | IPA (30) |
| glycerol (70) | IPA (30) |

The ingredients for compositions described herein including surfactants, solvents, and optionally water can be combined using techniques known in the art for combining these types of materials, including using conventional magnetic stir bars or mechanical mixer (e.g., in-line static mixer and recirculating pump).

The amount of solvent typically varies inversely with the amount of other components in compositions useful in practicing any of the methods disclosed herein. For example, based on the total weight of the composition the solvent may be present in the composition in an amount of from at least 10, 20, 30, 40, or 50 percent by weight or more up to 60, 70, 80, 90, 95, 98, or even 99 percent by weight, or more.

Generally, the amounts of the surfactant and solvent (and type of solvent) is dependent on the particular application since conditions typically vary between wells, at different depths of individual wells, and even over time at a given location in an individual well. Advantageously, treatment methods according to the present disclosure can be customized for individual wells and conditions.

The effectiveness of the methods disclosed herein for improving hydrocarbon productivity of a particular oil and/or gas well having brine and liquid hydrocarbons accumulated in the near wellbore region will typically be determined by the ability of the composition to dissolve the quantity of brine present in the near wellbore region of the well. Hence, at a given temperature greater amounts of compositions having lower brine solubility (i.e., compositions that can dissolve a relatively lower amount of brine) will typically be needed than in the case of compositions having higher brine solubility and containing the same surfactant at the same concentration.

In some embodiments of methods according to the present disclosure, the solvent in compositions useful in practicing the present disclosure solubilizes the brine in the hydrocarbon-bearing formation without causing the fluorinated anionic surfactant to precipitate. The phase behavior is typically evaluated prior to contacting the hydrocarbon-bearing formation with the composition by obtaining a sample of the brine from the hydrocarbon-bearing formation and/or analyzing the composition of the brine from the hydrocarbon-bearing formation. If a sample of the brine from the hydrocarbon-bearing formation is analyzed, an equivalent brine having the same or similar composition to the composition of the brine in the formation can be prepared. The brine and the composition (i.e., the surfactant-solvent composition) are combined (e.g., a in container) at the temperature and then mixed together (e.g., by shaking or stirring). The mixture is then maintained at the temperature for 15 minutes, removed from the heat, and immediately visually evaluated to see if surfactant precipitates. Precipitation may be as a solid, semi-solid, or combination thereof. Precipitation may also be as a liquid that does not go back into solution under the conditions of the evaluation.

The brine saturation level in a hydrocarbon-bearing formation can be determined using methods known in the art and can be used to determine the amount of brine that can be mixed with the surfactant-solvent composition in the phase behavior evaluation test. In some embodiments, the brine has at least 2, 3, 4, 5, 6, 7, 8, 9, or even at least 10 weight percent dissolved salts, based on the total weight of the brine. In some embodiments, the amount of brine that is added before precipitation occurs is at least 5, 10, 15, 20, 25, 30, 35, 40, 45, or even at least 50% by weight, based on the total weight of brine and surfactant-solvent composition combined in the phase behavior evaluation.

The phase behavior of the composition and the brine can be evaluated over an extended period of time (e.g., 1 hour, 12 hours, 24 hours, or longer) to determine if any precipitation or cloudiness is observed. By adjusting the relative amounts of brine and the surfactant-solvent composition, it is possible to determine the maximum brine uptake capacity (above which precipitation occurs) of the surfactant-solvent composition at a given temperature. Varying the temperature at which the above procedure is carried out typically results in a more complete understanding of the suitability of surfactant solvent compositions as treatment compositions for a given well.

In some embodiments, the fluorinated anionic surfactant is adsorbed on the surface of the hydrocarbon-bearing formation. Once adsorbed onto the formation, the fluorinated anionic surfactant can modify the wetting properties of the formation and cause an increase in at least one of gas, oil, or water permeability in the formation. Although not wishing to be bound by theory, it is believed that methods according to the present disclosure will provide more desirable results when the composition is homogenous at the temperature(s) encountered in the hydrocarbon-bearing formation (e.g., when it contacts the hydrocarbon-bearing formation). It is believed that once the composition contacts a hydrocarbon-bearing formation (e.g., downhole), the fluorinated anionic surfactant will adsorb onto the formation out of solution. Many variables (e.g., concentration of the fluorinated anionic surfactant, solvent composition, brine concentration and composition, hydrocarbon concentration and composition, and the presence of other components (e.g., other surfactants)) can affect the solution behavior of the composition.

In some embodiments, when the composition is contacting the hydrocarbon-bearing formation, the hydrocarbon-bearing formation is substantially free of precipitated salt. As used herein, the term “substantially free of precipitated salt” refers to an amount of salt that does not interfere with the ability of the composition (or the surfactant) to increase the gas permeability of the hydrocarbon-bearing formation. In some embodiments, “substantially free of precipitated salt” means that no precipitated can be visually observed. In some embodiments, “substantially free of precipitated salt” is an amount of salt that is less than 5% by weight higher than the solubility product at a given temperature and pressure.

In some embodiments of the methods disclosed herein, the surfactant is present in an amount sufficient to increase the gas permeability of the hydrocarbon-bearing formation. In some embodiments, the gas permeability after contacting the hydrocarbon-bearing formation with the composition is increased by at least 5 percent (in some embodiments, by at least 10, 15, 20, 30, 40, 50, 60, 70, 80, 90, or even 100 percent or more) relative to the gas permeability of the formation before contacting the formation with the composition. In some embodiments, the gas permeability is a gas relative permeability. In some embodiments, the liquid (e.g., oil or condensate) permeability in the hydrocarbon-bearing formation is also increased (in some embodiments, by at least 5, 10, 15, 20, 30, 40, 50, 60, 70, 80, 90, or even 100 percent or more) after contacting the formation with the composition.

In some embodiments of the methods disclosed herein, hydrocarbon-bearing formations have both gas and liquid hydrocarbons. In some of these embodiments, the liquid hydrocarbons may be condensate, black oil, or volatile oil. The term “black oil” refers to the class of crude oil typically having gas-oil ratios (GOR) less than about 2000 scf/stb (356 m³/m³). For example, a black oil may have a GOR in a range from about 100 (18), 200 (36), 300 (53), 400 (71), or even 500 scf/stb (89 m³/m³) up to about 1800 (320), 1900 (338), or even 2000 scf/stb (356 m³/m³). The term “volatile oil” refers to the class of crude oil typically having a GOR in a range between about 2000 and 3300 scf/stb (356 and 588 m³/m³). For example, a volatile oil may have a GOR in a range from about 2000 (356), 2100 (374), or even 2200 scf/stb (392 m³/m³) up to about 3100 (552), 3200 (570), or even 3300 scf/stb (588 m³/m³).

Typically, in compositions useful for practicing the methods described herein, the surfactant is present in the composition at at least 0.01, 0.015, 0.02, 0.025, 0.03, 0.035, 0.04, 0.045, 0.05, 0.055, 0.06, 0.065, 0.07, 0.075, 0.08, 0.085, 0.09, 0.095, 0.1, 0.15, 0.2, 0.25, 0.5, 1, 1.5, 2, 3, 4, or 5 percent by weight, up to 5, 6, 7, 8, 9, or 10 percent by weight, based on the total weight of the composition. For example, the amount of the surfactant in the compositions may be in a range of from 0.01 to 10, 0.1 to 10, 0.1 to 5, 1 to 10, or even in a range from 1 to 5 percent by weight, based on the total weight of the composition. Lower and higher amounts of the surfactant in the compositions may also be used, and may be desirable for some applications.

Methods according to the present disclosure may be practiced, for example, in a laboratory environment (e.g., on a core sample (i.e., a portion) of a hydrocarbon-bearing formation) or in the field (e.g., on a subterranean hydrocarbon-bearing formation situated downhole). Typically, the methods disclosed herein are applicable to downhole conditions having a pressure in a range from about 1 bar (100 kPa) to about 1000 bars (100 MPa) and have a temperature in a range from about 100° F. (37.8° C.) to 400° F. (204° C.) although the methods are not limited to hydrocarbon-bearing formations having these conditions. The skilled artisan, after reviewing the instant disclosure, will recognize that various factors may be taken into account in practice of the any of the disclosed methods including, for example, the ionic strength of the brine, pH (e.g., a range from a pH of about 4 to about 10), and the radial stress at the wellbore (e.g., about 1 bar (100 kPa) to about 1000 bars (100 MPa)).

In the field, contacting a hydrocarbon-bearing formation with a composition described herein can be carried out using methods (e.g., by pumping under pressure) well known to those skilled in the oil and gas art. Coil tubing, for example, may be used to deliver the treatment composition to a particular geological zone of a hydrocarbon-bearing formation. In some embodiments of practicing the methods described herein it may be desirable to isolate a geological zone (e.g., with conventional packers) to be contacted with the composition.

Methods of using compositions described herein are useful, for example on both existing and new wells. Typically, it is believed to be desirable to allow for a shut-in time after compositions described herein are contacted with the hydrocarbon-bearing formations. Exemplary shut-in times include a few hours (e.g., 1 to 12 hours), about 24 hours, or even a few (e.g., 2 to 10) days. After the composition has been allowed to remain in place for a selected time, the solvents present in the composition may be recovered from the formation by simply pumping fluids up tubing in a well as is commonly done to produce fluids from a formation.

In some embodiments of methods according to the present disclosure, the method comprises contacting the hydrocarbon-bearing formation with a fluid prior to contacting the hydrocarbon-bearing formation with the composition, wherein the fluid at least one of partially solubilizes or partially displaces the brine in the hydrocarbon-bearing formation. In some embodiments, the fluid partially solubilizes the brine. In some embodiments, the fluid partially displaces the brine. In some embodiments, the fluid is substantially free of fluorinated surfactants. The term “substantially free of fluorinated surfactants” refers to fluid that may have a fluorinated surfactant in an amount insufficient for the fluid to have a cloud point (e.g., when it is below its critical micelle concentration). A fluid that is substantially free of fluorinated surfactants may be a fluid that has a fluorinated surfactant but in an amount insufficient to alter the wettability of, for example, a hydrocarbon-bearing formation under downhole conditions. A fluid that is substantially free of fluorinated surfactants includes those that have a weight percent of such surfactants as low as 0 weight percent. The fluid may be useful for decreasing the concentration of at least one of the salts present in the brine prior to introducing the composition to the hydrocarbon-bearing formation. The change in brine composition may change the results of the phase evaluation (e.g., the combination of a composition with a first brine prior to the fluid preflush may result in phase separation while the combination of the composition with the brine after the fluid preflush may result in one liquid phase.) In some embodiments, the fluid comprises at least one of toluene, diesel, heptane, octane, or condensate. In some embodiments, the fluid comprises at least one of water, methanol, ethanol, or isopropanol. In some embodiments, the fluid comprises at least one of a polyol or polyol ether independently having from 2 to 25 carbon atoms. In some embodiments, useful polyols have 2 to 20, 2 to 15, 2 to 10, 2 to 8, or even 2 to 6 carbon atoms. Exemplary useful polyols include ethylene glycol, propylene glycol, polypropylene glycol), 1,3-propanediol, trimethylolpropane, glycerol, pentaerythritol, and 1,8-octanediol. In some embodiments, useful polyol ethers may have from 3 to 25 carbon atoms, 3 to 20, 3 to 15, 3 to 10, 3 to 8, or even from 5 to 8 carbon atoms. Exemplary useful polyol ethers include diethylene glycol monomethyl ether, ethylene glycol monobutyl ether, dipropylene glycol monomethyl ether, 2-butoxyethanol, and 1-methoxy-2-propanol. In some embodiments, the fluid comprises at least one monohydroxy alcohol, ether, or ketone independently having up to four carbon atoms. In some embodiments, the fluid comprises at least one of nitrogen, carbon dioxide, or methane.

In some embodiments, the fluid at least one of partially solubilizes or displaces the liquid hydrocarbons in the hydrocarbon-bearing formation.

In some embodiments of the methods disclosed herein, the hydrocarbon-bearing formation has at least one fracture. In some embodiments, fractured formations have at least 2, 3, 4, 5, 6, 7, 8, 9, or even 10 or more fractures. As used herein, the term “fracture” refers to a fracture that is man-made. In the field, for example, fractures are typically made by injecting a fracturing fluid into a subterranean geological formation at a rate and pressure sufficient to open a fracture therein (i.e., exceeding the rock strength).

In some embodiments of the treatment methods disclosed herein, wherein contacting the formation with the composition provides an increase in at least one of the gas permeability or the liquid permeability of the formation, the formation is a non-fractured formation (i.e., free of man-made fractures). Advantageously, treatment methods disclosed herein typically provide an increase in at least one of the gas permeability or the liquid permeability of the formation without fracturing the formation.

In some of embodiments of the treatment methods disclosed herein, wherein the hydrocarbon-bearing formation has at least one fracture, the fracture has a plurality of proppants therein. Prior to delivering the proppants into a fracture, the proppants may be treated with a fluorinated surfactant (e.g., a fluorinated anionic surfactant) or may be untreated (e.g., may comprise less than 0.1% by weight fluorinated anionic surfactant, based on the total weight of the plurality of proppants). Exemplary proppants known in the art include those made of sand (e.g., Ottawa, Brady or Colorado Sands, often referred to as white and brown sands having various ratios), resin-coated sand, sintered bauxite, ceramics (i.e., glasses, crystalline ceramics, glass-ceramics, and combinations thereof), thermoplastics, organic materials (e.g., ground or crushed nut shells, seed shells, fruit pits, and processed wood), and clay. Sand proppants are available, for example, from Badger Mining Corp., Berlin, Wis.; Borden Chemical, Columbus, Ohio; and Fairmont Minerals, Chardon, Ohio. Thermoplastic proppants are available, for example, from the Dow Chemical Company, Midland, Mich.; and BJ Services, Houston, Tex. Clay-based proppants are available, for example, from CarboCeramics, Irving, Tex.; and Saint-Gobain, Courbevoie, France. Sintered bauxite ceramic proppants are available, for example, from Borovichi Refractories, Borovichi, Russia; 3M Company, St. Paul, Minn.; CarboCeramics; and Saint Gobain. Glass bubble and bead proppants are available, for example, from Diversified Industries, Sidney, British Columbia, Canada; and 3M Company.

In some embodiments, the proppants form packs within a formation and/or wellbore. Proppants may be selected to be chemically compatible with the solvents and compositions described herein. The term “proppant” as used herein includes fracture proppant materials introducible into the formation as part of a hydraulic fracture treatment and sand control particulate introducible into the wellbore/formation as part of a sand control treatment such as a gravel pack or frac pack.

In some embodiments, methods according to the present disclosure include contacting the hydrocarbon-bearing formation with the composition at least one of during fracturing or after fracturing the hydrocarbon-bearing formation.

In some embodiments of methods of treated fractured formations, the amount of the composition introduced into the fractured formation is based at least partially on the volume of the fracture(s). The volume of a fracture can be measured using methods that are known in the art (e.g., by pressure transient testing of a fractured well). Typically, when a fracture is created in a hydrocarbon-bearing subterranean formation, the volume of the fracture can be estimated using at least one of the known volume of fracturing fluid or the known amount of proppant used during the fracturing operation. Coil tubing, for example, may be used to deliver the treatment composition to a particular fracture. In some embodiments, in practicing the methods disclosed herein it may be desirable to isolate the fracture (e.g., with conventional packers) to be contacted with the treatment composition.

In some embodiments, wherein the formation treated according to the methods described herein has at least one fracture, the fracture has a conductivity, and after the composition contacts at least one of the fracture or at least a portion of the plurality of proppants, the conductivity of the fracture is increased (e.g., by 25, 50, 75, 100, 125, 150, 175, 200, 225, 250, 275, or even by 300 percent).

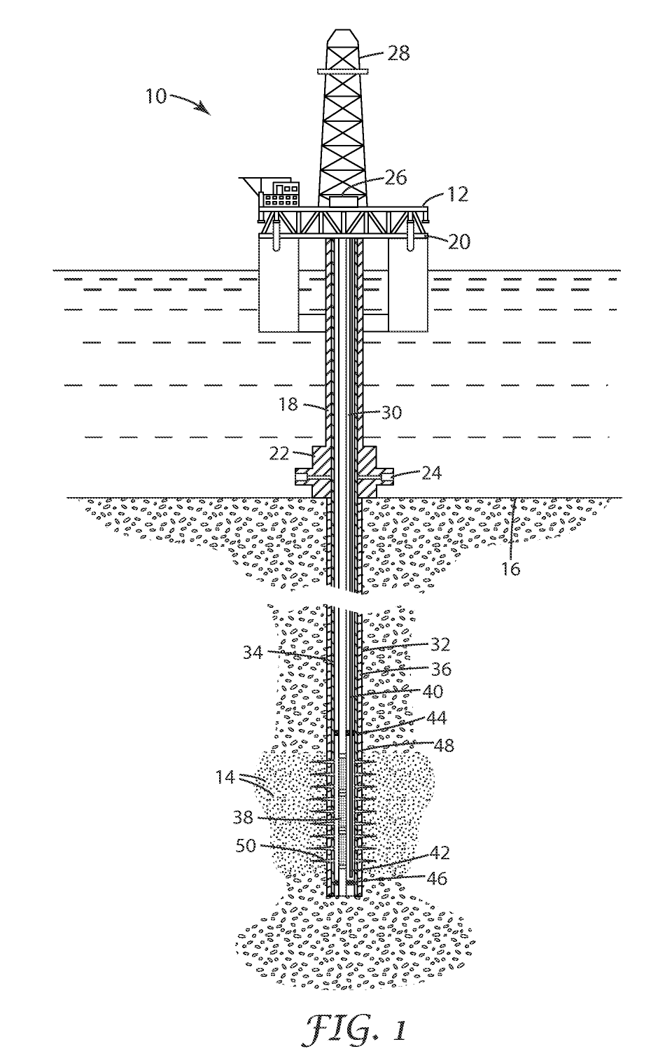

Referring to FIG. 1, an exemplary offshore oil platform is schematically illustrated and generally designated 10. Semi-submersible platform 12 is centered over submerged hydrocarbon-bearing formation 14 located below sea floor 16. Subsea conduit 18 extends from deck 20 of platform 12 to wellhead installation 22 including blowout preventers 24. Platform 12 is shown with hoisting apparatus 26 and derrick 28 for raising and lowering pipe strings such as work string 30.

Wellbore 32 extends through the various earth strata including hydrocarbon-bearing formation 14. Casing 34 is cemented within wellbore 32 by cement 36. Work string 30 may include various tools including, for example, sand control screen assembly 38 which is positioned within wellbore 32 adjacent to hydrocarbon-bearing formation 14. Also extending from platform 12 through wellbore 32 is fluid delivery tube 40 having fluid or gas discharge section 42 positioned adjacent to hydrocarbon-bearing formation 14, shown with production zone 48 between packers 44, 46. When it is desired to treat the near-wellbore region of hydrocarbon-bearing formation 14 adjacent to production zone 48, work string 30 and fluid delivery tube 40 are lowered through casing 34 until sand control screen assembly 38 and fluid discharge section 42 are positioned adjacent to the near-wellbore region of hydrocarbon-bearing formation 14 including perforations 50. Thereafter, a composition described herein is pumped down delivery tube 40 to progressively treat the near-wellbore region of hydrocarbon-bearing formation 14.

While the drawing depicts an offshore operation, the skilled artisan will recognize that the methods for treating a production zone of a wellbore are equally well-suited for use in onshore operations. Also, while the drawing depicts a vertical well, the skilled artisan will also recognize that methods according to the present disclosure are equally well-suited for use in deviated wells, inclined wells or horizontal wells.

Advantages and embodiments of the methods disclosed herein are further illustrated by the following examples, but the particular materials and amounts thereof recited in these examples, as well as other conditions and details, should not be construed to unduly limit this invention. Unless otherwise noted, all parts, percentages, ratios, etc. in the examples and the rest of the specification are by weight. In the Tables, “nd” means not determined.

### Examples

### Surfactants

Fluorinated surfactant 1 was an anionic fluorinated surfactant represented by formula CF₃CF₂(CF₂CF₂)₂₋₄CH₂CH₂—O)ₓ—P(O)—(O⁻NH₂⁺[CH₂CH₂OH]₂)₃₋ₓ obtained from E. I. du Pont de Nemours and Co., Wilmington, Del., under the trade designation “ZONYL 9361”.

Fluorinated surfactant 2 was an anionic fluorinated surfactant obtained from Omnova Solutions Inc., Fairlawn, Ohio, under the trade designation “POLYFOX PF-156A”.

Fluorinated surfactant 3 was an anionic fluorinated surfactant obtained from Omnova Solutions Inc. under the trade designation “POLYFOX PF-136A”.

Fluorinated surfactant 4 was an anionic fluorinated surfactant represented by formula C₈F₁₇SO₂N(C₂H₅)CH₂CO₂⁻K⁺ obtained from 3M Company, St. Paul, Minn., under the trade designation “FC-129”.

Fluorinated surfactant 5 was prepared according to the following procedure.

N-Methylperfluorobutanesulfonamidoethyl acrylate (MeFBSEA) (372.0 g, 904.6 mmol), acrylic acid (16.3 g, 226 mmol), 3-mercaptopropionic acid (12.0 g, 113 mmol), 2,2′-azobis(2-methylbutyronitrile) (4.0 g, 20.1 mmol), and ethyl acetate (1200 g) were combined, and the resulting solution was divided into four 1-quart bottles. Each solution was purged with nitrogen at one liter per minute for two minutes and then heated under a nitrogen atmosphere for 44 hours at 60° C. in a rotating water bath. The contents of the four bottles were combined and concentrated under reduced pressure to provide 422.4 g of liquid. A one-gram sample of the liquid was heated for four hours at 105° C., and the residue was weighed to determine that the liquid was 92% solids. The percent conversion, calculated according to the following equation:

percent conversion=100 [(percent solids×weight of solution)/weight of starting monomers], was 97%.

A portion of the 422.4 grams of liquid was diluted with tetrahydrofuran to 61% solids. A 10-gram sample of this material was treated with 1.7 gram (14 mmol) of N-methyldiethanolamine to prepare Fluorinated Surfactant 5 as a 52% solids solution.

The weight average molecular weight measured by gel permeation chromatography (GPC) was 3810. The GPC measurement was carried out using four 300 mm by 7.5 mm linear columns of 5 micrometer styrene divinylbenzene copolymer particles (obtained from Polymer Laboratories, Shropshire, UK, under the trade designation “PLGEL”) with pore sizes of 10,000, 1000, 500, and 100 angstroms. An evaporative light scattering detector from Polymer Laboratories was used at 45° C. and a nitrogen flow rate of 10 mL/min. A 50-milligram (mg) sample of oligomer at 25% solids in ethyl acetate was diluted with 4 mL of tetrahydrofuran and treated with diazomethane. The resulting solution was dried under a stream of nitrogen, and the sample was then diluted with tetrahydrofuran (10 mL of UV grade) and filtered through a 0.45 micrometer syringe filter. A sample volume of 50 microliters was injected onto the column, and the column temperature was room temperature. A flow rate of 1 mL/minute was used. Molecular weight calibration was performed using narrow dispersity polystyrene standards with peak average molecular weights ranging from 1.1×10⁶ grams per mole to 580 grams per mole. Calibration and molecular weight distribution calculations were performed with GPC software using a third order polynomial fit for the molecular weight calibration curve.

MeFBSEA, which was used to prepare fluorinated surfactant 5, was made according to the method of U.S. Pat. No. 6,664,354 (Savu), Example 2, Parts A and B, incorporated herein by reference, except using 4270 kg of N-methylperfluorobutanesulfonamidoethanol, 1.6 kg of phenothiazine, 2.7 kg of methoxyhydroquinone, 1590 kg of heptane, 1030 kg of acrylic acid, 89 kg of methanesulfonic acid (instead of triflic acid), and 7590 kg of water in Part B.

Fluorinated surfactant 6 was an anionic, water-dilutable fluorochemical for porous surface treatments obtained from E. I. du Pont de Nemours and Co. under the trade designation “ZONYL 9027”.

Comparative fluorinated surfactant 7 was a cationic water-dilutable fluoropolymer for porous surface treatments obtained from E. I. du Pont de Nemours and Co. under the trade designation “ZONYL 8740”.

Fluorinated surfactant 8 was potassium perfluorobutanesulfonate, prepared as described in U.S. Pat. No. 6,664,354 (Savu et al.) at column 17 to column 18, the disclosure of which preparation is incorporated herein by reference.

Fluorinated surfactant 9 was [C₄F₉SO₂N(CH₃)CH₂]₂CHOCH₂COOK, prepared as described in Example 4 of U.S. Pat. No. 7,160,850 (Dams et al.), the disclosure of which example is incorporated herein by reference.

Fluorinated surfactant 10 was CF₃OCF₂OCF₂OCF₂OCF₂C(O)O-½Ca²⁺, which was prepared by treating perfluoro-3,5,7,9-tetraoxadecanoic acid, obtained from Anles Ltd., St Petersburg, Russia with Ca(OH)₂, available from Aldrich, Bornem, Belgium in a mixture of 80% by weight ethanol and 20% by weight water.

### Brines

Water (92.25%) 5.9% sodium chloride, 1.6% calcium chloride, 0.23% magnesium chloride hexahydrate, and 0.05% potassium chloride were combined to provide Brine 1.

Water (97%) and 3% potassium chloride were combined to provide Brine 2.

### Compatibility Evaluations

A surfactant (0.06 gram (g)) and solvents (Solvent A and Solvent B) were added to a vial to prepare a sample (3 g total amount, 2% w/w of surfactant). Brine was added to the vial, and the vial was placed in a heated bath at 135° C. for 15 minutes. The vial was removed from the bath, and then visually inspected immediately to determine whether the sample was one phase.

The surfactant, solvents, and brine used for each Compatibility Evaluation are shown in Table 2 (below).

TABLE 2

| Surfac- | Solvent A | Solvent B | Brine | |
|---|---|---|---|---|
| tant | (weight %) | (weight %) | (amount) | Result |
| 1 | Propylene glycol | Isopropanol | 1 | Slightly |
| | (PG) (69) | (IPA) (29) | (1 gram) | hazy, one |
| | | | | phase |
| 2 | PG (69) | IPA (29) | 1 | Slightly |
| | | | (1 gram) | hazy, one |
| | | | | phase |
| 3 | PG (69) | IPA (29) | 2 | One phase |
| | | | (0.75 gram) | |
| 4 | Ethylene glycol | IPA (29) | 2 | One phase |
| | (EG) (69) | | (0.25 gram) | |
| 5 | 2-Butoxyethanol | IPA (29) | 1 | Moderately |
| | (BE) (69) | | (0.25 gram) | hazy, one |
| | | | | phase |
| 6 | PG (69) | IPA (29) | 1 | Surfactant |
| | | | (1 gram) | precipitated |
| 7 | PG (69) | IPA (29) | 1 | One phase |
| | | | (1 gram) | |
| 1 | Methanol (98) | Not used | 2 | One phase |
| | | | (1 gram) | |
| 1 | Methanol (98) | Not used | 1 | Two phases |
| | | | (1 gram) | |
| 2 | Methanol (98) | Not used | 1 | Two phases, |
| | | | (1 gram) | precipitation |
| 3 | Methanol (98) | Not used | 1 | Two phases, |
| | | | (1 gram) | precipitation |
| 4 | Methanol (98) | Not used | 1 | Two phases |
| | | | (1 gram) | |

### Examples 1 to 5 and Comparative Examples A and B

### Composition Preparation:

A surfactant and two solvents (Solvent A and Solvent B) were combined to make 600 grams of a 2% by weight solution of the surfactant. The components were mixed together using a magnetic stirrer and magnetic stir bar. The surfactants, solvents, and amounts (in wt. % based on the total weight of the composition used for Examples 1 to 5 and Comparative Examples A and B are shown in Table 3, below.

TABLE 3

| Example | Surfactant | Solvent A | Solvent B |
|---|---|---|---|
| 1 | 1 (2) | PG (69) | IPA (29) |
| 2 | 2 (2) | PG (69) | IPA (29) |
| 3 | 3 (2) | PG (69) | IPA (29) |
| 4 | 4 (2) | EG (69) | IPA (29) |
| 5 | 5 (2) | BE (69) | IPA (29) |
| Comp. Ex. A | 7 (2) | PG (69) | IPA (29) |
| Comp. Ex. B | none | PG (70) | IPA (30) |

### Core Flood Setup:

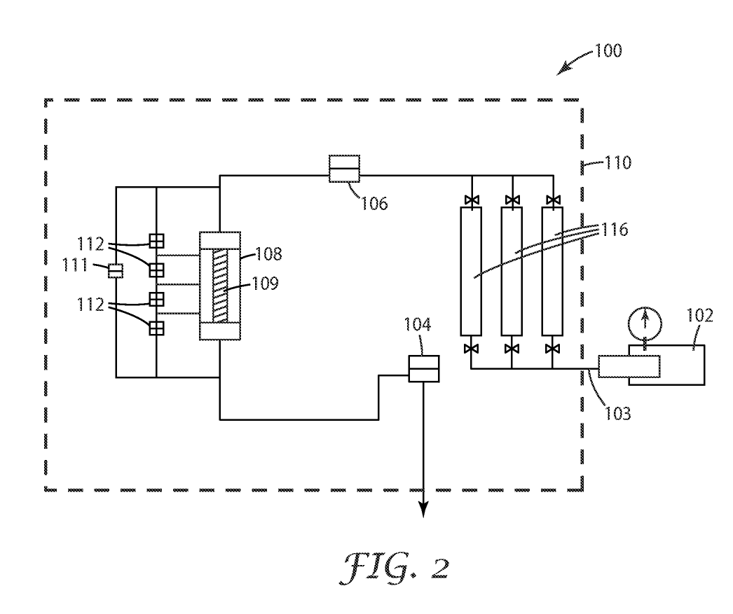

A schematic diagram of a core flood apparatus 100 used to determine relative permeability of a substrate sample (i.e., core) is shown in FIG. 2. Core flood apparatus 100 included positive displacement pumps (Model No. 1458; obtained from General Electric Sensing, Billerica, Mass.) 102 to inject fluid 103 at constant rate into fluid accumulators 116. Multiple pressure ports 112 on high-pressure core holder 108 (Hassler-type Model UTPT-1x8-3K-13 obtained from Phoenix, Houston, Tex.) were used to measure pressure drop across four sections (2 inches in length each) of core 109. An additional pressure port 111 on core holder 108 was used to measure pressure drop across the entire length (8 inches) of core 109. Two back-pressure regulators (Model No. BPR-50; obtained from Temco, Tulsa, Okla.) 104, 106 were used to control the flowing pressure upstream 106 and downstream 104 of core 109.

The flow of fluid was through a vertical core to avoid gravity segregation of the gas. High-pressure core holder 108, back pressure regulators 106, fluid accumulators 116, and tubing were placed inside a pressure- and temperature-controlled oven 110 (Model DC 1406F; maximum temperature rating of 650° F. (343° C.); obtained from SPX Corporation, Williamsport, Pa.) at 275° F. (135° C.). The maximum flow rate of fluid was 7,000 mL/hr.

### Cores:

A core sample was cut from a Berea sandstone block. One core was used for each of Examples 1 to 5 and for each of Comparative Examples A and B. The properties for each of the cores used are shown in Table 4, below.

TABLE 4

| | Ex. 1 | Ex. 2 | Ex. 3 | Ex. 4 | Ex. 5 | C. E. A | C. E. B |
|---|---|---|---|---|---|---|---|
| Diameter, cm | 2.6 | 2.6 | 2.5 | 2.5 | 2.5 | 2.5 | 2.6 |
| Length, cm | 14.7 | 14.6 | 14.6 | 14.6 | 14.6 | 14.6 | 14.6 |
| Pore volume, mL | 14.2 | 14.7 | 13.5 | 13.6 | 13.5 | 13.4 | 15.2 |
| Porosity, % | 18.5 | 19.4 | 19.0 | 19.0 | 19.0 | 19.0 | 19.4 |

The porosity was measured using a gas expansion method. The pore volume is the product of the bulk volume and the porosity.

### Synthetic Condensate Composition:

A synthetic gas-condensate fluid containing 93 mole percent methane, 4 mole percent n-butane, 2 mole percent n-decane, and 1 mole percent n-pentadecane was used for the core flooding evaluation. Approximate values for various properties of the fluid are reported Table 5, below.

TABLE 5

| | |
|---|---|
| Dewpoint, psig (Pa) | 4200 (2.9 × 10⁷) |
| Core pressure, psig (Pa) | 1500 (1.0 × 10⁷) |
| Liquid dropout, V/Vt % | 3.2 |
| Gas viscosity, cP | 0.017 |
| Oil viscosity, cP | 0.22 |
| Interfacial tension, | 5.0 |
| dynes/cm | |

### Core Flood Procedure:

The cores described in Table 4 were dried for 72 hours in a standard laboratory oven at 95° C., and then were wrapped in aluminum foil and heat shrink tubing (obtained under the trade designation “TEFLON HEAT SHRINK TUBING” from Zeus, Inc., Orangeburg, S.C.). Referring again to FIG. 2, the wrapped core 109 was placed in core holder 108 inside oven 110 at 75° F. (24° C.). An overburden pressure of 3400 psig (2.3×10⁷ Pa) was applied. The initial single-phase gas permeability was measured using nitrogen at a flowing pressure of 1200 psig (8.3×10⁶ Pa).

The brine (Brine 1 or Brine 2) was introduced into the core 109 by the following procedure. The outlet end of the core holder was connected to a vacuum pump and a full vacuum was applied for 30 minutes with the inlet closed. The inlet was connected to a burette with the brine in it. The outlet was closed and the inlet was opened to allow a known volume of brine to flow into the core. For example, a 26% brine saturation (i.e., 26% of the pore volume of the core was saturated with brine) was established by allowing 5.3 mL of brine to flow into the core before the inlet value was closed. The permeability was measured at the water saturation by flowing nitrogen at 1200 psig and 75° F. (24° C.).

Referring again to FIG. 2, the wrapped core 109 in the core holder 108 was placed inside oven 110 at 275° F. (135° C.) for several hours to allow it to reach reservoir temperature. The synthetic gas-condensate fluid described above was then introduced at a flow rate of about 690 mL/hr until steady state was established. Upstream back-pressure regulator 106 was set at about 4900 psig (3.38×10⁷ Pa), above the dew point pressure of the fluid, and downstream back-pressure regulator 104 was set at about 1500 psig (3.38×10⁷ Pa). The gas relative permeability before treatment was then calculated from the steady state pressure drop after about 200 pore volumes. The surfactant composition was then injected into the core. After at least 20 pore volumes were injected, the surfactant composition was held in the core at 275° F. (135° C.) for about 15 hours. The synthetic gas condensate fluid described above was then introduced again at a flow rate of about 690 mL/hour using positive displacement pump 102 until a steady state was reached (about 150 to 200 pore volumes). The gas relative permeability after treatment was then calculated from the steady state pressure drop. For Examples 3 and 4 and Comparative Example B, the core was allowed to stand in the presence of the synthetic condensate compositions for about 24 hours before a second core flood was run. For Example 2, the core was allowed to stand in the presence of the synthetic condensate compositions for about 3 hours before a second core flood was run and then allowed to stand in the presence of condensate for about 3 days total before a third core flood was run.

Following the relative permeability measurements, methane gas was injected, using positive displacement pump 102, to displace the condensate and measure the final single-phase gas permeability.

For Examples 1 to 5 and Comparative Examples A and B, the initial single-phase gas permeability, measured after brine saturation, the brine and brine saturation, the gas relative permeability before treatment with the surfactant composition, the gas relative permeability after treatment (at the times described above), the ratio of the gas relative permeabilities after and before treatment (i.e., improvement factor) are reported in Table 6, below.

TABLE 6

| | 1 | 2 | 3 | 4 | 5 | C. E. A | C. E. B |
|---|---|---|---|---|---|---|---|
| Gas | 380.3 | 296.7 | 137.3 | 186.3 | 177.6 | | 357.5 |
| permeability, | | | | | | | |
| millidarcy | | | | | | | |
| (md) | | | | | | | |
| Brine | 1 (26%) | 1 (26%) | 2 (20%) | 2 (7.7%) | 1 (26%) | 1 (26%) | 1 (26%) |
| (saturation) | | | | | | | |
| Gas relative | 0.061 | 0.062 | 0.068 | 0.064 | 0.068 | 0.068 | 0.069 |
| permeability | | | | | | | |
| before | | | | | | | |
| treatment | | | | | | | |
| Gas relative | 0.099 | 0.127/0.102/0.085 | 0.142/0.112 | 0.09/0.101 | 0.089 | plugged | 0.115/0.099 |
| permeability | | | | | | | |
| after | | | | | | | |
| treatment | | | | | | | |
| Improvement | 1.62 | 2.05/1.65/1.37 | 2.09/1.65 | 1.40/1.58 | 1.3 | n.d. | 1.67/1.43 |
| factor | | | | | | | |

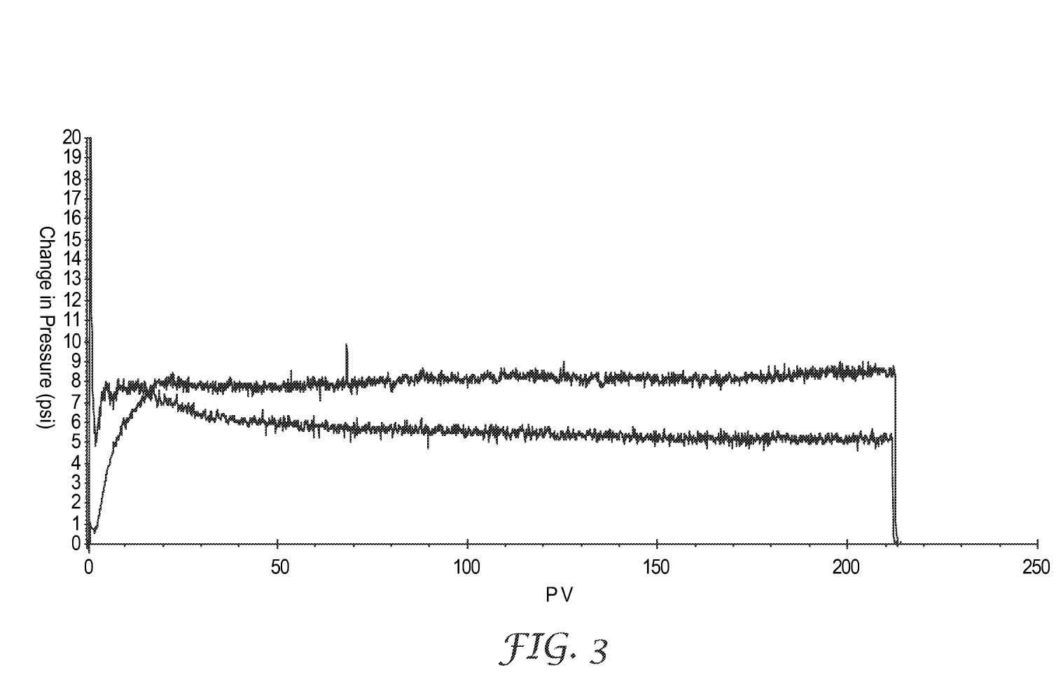

FIG. 3 depicts the graph of the pressure drop versus pore volumes for the two-phase core flood of Example 1. In FIG. 3, the upper line corresponds to the pre-treatment two-phase core flood, and the lower line corresponds to the post-treatment two-phase core flood.

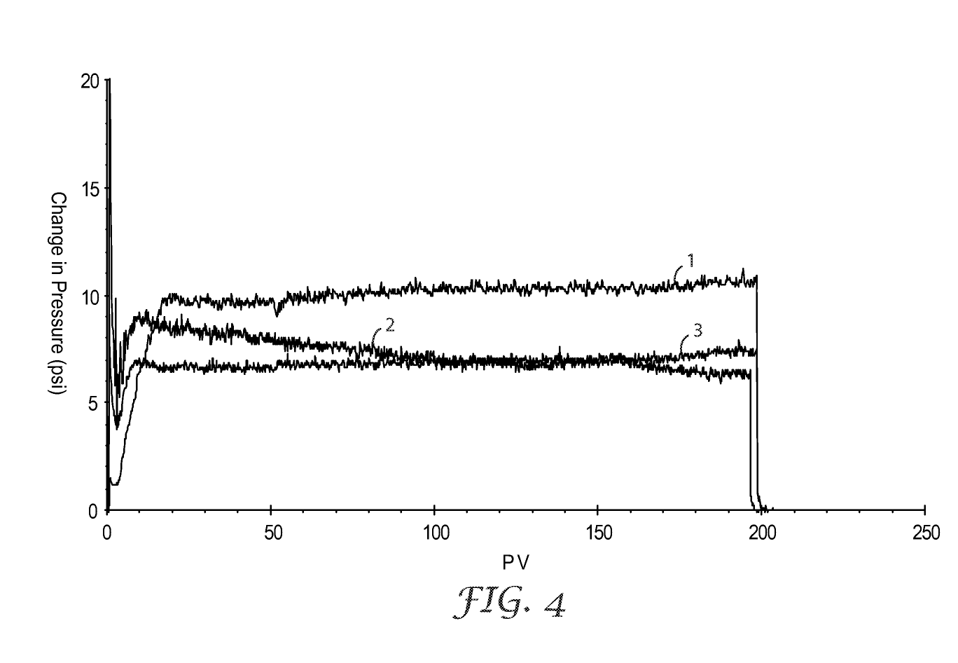

FIG. 4 depicts the graph of the pressure drop versus pore volumes for the two-phase core flood of Comparative Example B. In FIG. 4, line 1 corresponds to the pre-treatment two-phase core flood, line 2 corresponds to the first post-treatment two-phase core flood, and line 3 corresponds to the second post-treatment two-phase core flood.

### Examples 6 to 8

### Treatment Composition Preparation:

For Examples 6 and 7, respectively, fluorinated surfactant 8 was dissolved at 1% by weight in ethanol, and fluorinated surfactant 9 was combined at 1% by weight with 89.5% by weight ethanol and 9.5% by weight water.

For Example 8, fluorinated surfactant 10 was combined at 1% by weight with 79.2% by weight ethanol and 19.8% by weight water.

### Flow Setup and Procedure:

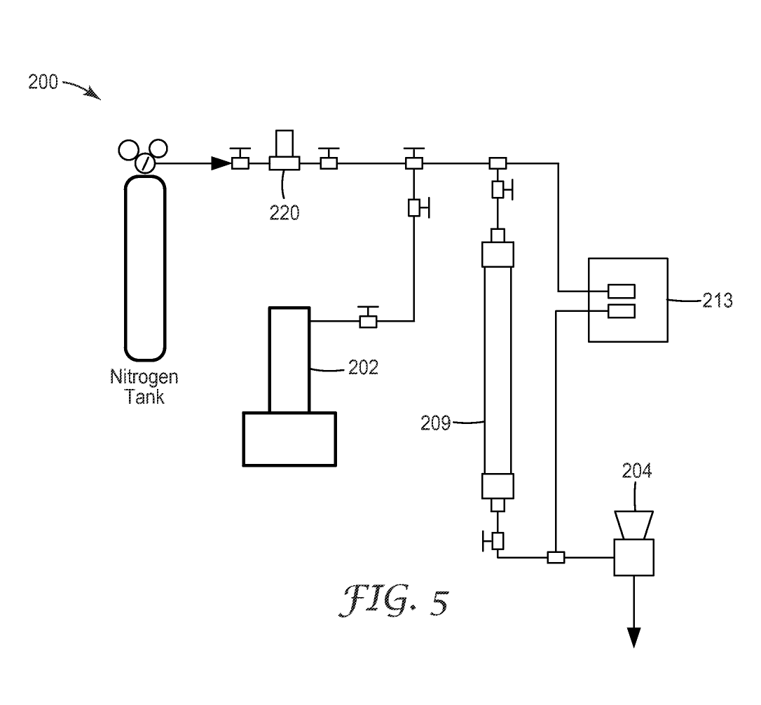

A schematic diagram of a flow apparatus 200 used to determine relative permeability of particulate calcium carbonate is shown in FIG. 5. Flow apparatus 200 included positive displacement pump 202 (Model Gamma/4-W 2001 PP, obtained from Prolingent AG, Regensdorf, Germany) to inject n-heptane at constant rate. Nitrogen gas was injected at constant rate through a gas flow controller 220 (Model DK37/MSE, Krohne, Duisburg, Germany). Pressure indicators 213, obtained from Siemens under the trade designation “SITRANS P” 0-16 bar, were used to measure the pressure drop across a particulate calcium carbonate pack in vertical core holder 209 (stainless steel grade SS316, 20 cm by 12.5 cm²) (obtained from 3M Company, Antwerp, Belgium). A back-pressure regulator (Model No. BS(H)2, obtained from RHPS, the Netherlands) 204 was used to control the flowing pressure upstream and downstream of core holder 209. Core holder 209 was heated by circulating silicone oil, heated by a heating bath obtained from Lauda, Switzerland, under the trade designation “HEATING BATH R22”.

The core holder was filled with particulate calcium carbonate (obtained from Merck, Darmstadt, Germany as granular marble, particle size in a range from 0.5 mm to 2 mm) and then heated to 75° C. The temperature of 75° C. was maintained for each of the flows in Examples 6 to 8. A pressure of about 5 bar (5×10⁵ Pa) was applied, and the back pressure was regulated in such a way that the flow of nitrogen gas through the particulate calcium carbonate was about 450 to 1000 mL/minute. The initial gas permeability was calculated using Darcy's law.

Synthetic brine, prepared according to the natural composition of North Sea brine, was prepared by mixing 5.9% sodium chloride, 1.6% calcium chloride, 0.23% magnesium chloride, 0.05% potassium chloride and distilled water up to 100% by weight. The brine was introduced into the core holder at about 1 mL/minute using displacement pump 202.

Heptane was then introduced into the core holder at about 0.5 mL/minute using displacement pump 202. Nitrogen and n-heptane were co-injected into the core holder until steady state was reached. The gas permeability before treatment was then calculated from the steady state pressure drop.

The surfactant composition was then injected into the core at a flow rate of 1 mL/minute for about one pore volume. The gas permeability and improvement factor (permeability after treatment/permeability before treatment) were calculated.

Heptane was then injected for about six pore volumes (170 grams). The gas permeability and improvement factor were again calculated.

For Examples 6 to 8, the liquid used for each injection, the initial pressure, the pressure change (ΔP), the flow rate for each injection, the amount of liquid used for each injection, flow rate of gas through the core (Q), the gas permeability (K), and the improvement factor (PI) are shown in Table 7, below.

TABLE 7

| | | | | | Amount | | | |
|---|---|---|---|---|---|---|---|---|
| | | Pressure | | Flow | Liquid | Q | K | |
| Example | Liquid | (initial) | ΔP | (mL/min) | (g) | (mL/second) | (Darcy) | PI |
| 6 | none | 5.1 | 0.01 | 450 | none | 7.5 | 20.4 | |
| | brine | 5.2 | 0.14 | 450 | 42 | 8.0 | 1.5 | |
| | heptane | 5.3 | 0.13 | 460 | 82 | 8.1 | 1.7 | |
| | Ex. 6 | 5.3 | 0.13 | 490 | 17 | | | |
| | Comp. | | | | | | | |
| | Ex. 6 | 5.2 | 0.06 | 520 | 50 | 8.9 | 4.2 | 2.5 |
| | Comp. | | | | | | | |
| | heptane | 5.2 | 0.06 | 500 | 170 | 8.6 | 4.1 | 2.5 |
| 7 | none | 5.1 | 0.01 | 450 | none | 7.5 | 20.4 | |
| | brine | 5.4 | 0.14 | 440 | 48 | 7.9 | 1.5 | |
| | heptane | 5.3 | 0.14 | 440 | 88 | 7.9 | 1.5 | |
| | Ex. 7 | 5.5 | 0.06 | 420 | 40 | 7.2 | 3.3 | 2.1 |
| | Comp. | | | | | | | |
| | heptane | 5.5 | 0.06 | 440 | 170 | 7.6 | 3.4 | 2.2 |
| 8 | none | 4.9 | 0.01 | 530 | none | 8.8 | 24.0 | |
| | brine | 5.0 | 0.15 | 500 | 41 | 9.0 | 1.6 | |
| | heptane | 5.3 | 0.14 | 420 | 80 | 7.5 | 1.5 | |
| | Ex. 8 | 5.2 | 0.06 | 380 | 42 | 6.5 | 2.8 | 2.0 |
| | Comp. | | | | | | | |
| | heptane | 5.3 | 0.06 | 380 | 180 | 6.5 | 2.9 | 2.0 |
| Control | none | 5.0 | 0.01 | 580 | none | 9.7 | 26.3 | |
| Ex. A | brine | 5.4 | 0.15 | 500 | 48 | 9.0 | 1.6 | |
| | heptane | 5.4 | 0.11 | 420 | 60 | 7.4 | 1.9 | |
| | ethanol | 5.7 | 0.07 | 450 | 100 | 7.8 | 2.9 | 1.5 |
| | heptane | 5.4 | 0.10 | 380 | 150 | 6.6 | 1.8 | 0.9 |

### Control Example A

Control Example A was carried out according to the method of Examples 6 to 8 with the exception that the treatment composition contained only ethanol. The liquid used for each injection, the initial pressure, the pressure change (ΔP), the flow rate for each injection, the amount of liquid used for each injection, the flow rate of gas through the core (Q), the gas permeability (K), and the improvement factor (PI) are shown in Table 7, above.

Various modifications and alterations of this disclosure may be made by those skilled the art without departing from the scope and spirit of the disclosure, and it should be understood that this invention is not to be unduly limited to the illustrative embodiments set forth herein.

1. A method of treating a hydrocarbon-bearing formation having brine and liquid hydrocarbons, wherein the hydrocarbon-bearing formation has a gas permeability, the method comprising:
contacting the hydrocarbon-bearing formation having brine and liquid hydrocarbons with a composition comprising solvent and a fluorinated anionic surfactant, wherein the fluorinated anionic surfactant is present in an amount sufficient to increase the gas permeability of the hydrocarbon-bearing formation, and wherein the solvent solubilizes the brine in the hydrocarbon-bearing formation without causing the fluorinated anionic surfactant to precipitate.

2. The method of claim 1, wherein the solvent comprises at least one of a polyol or polyol ether independently having from 2 to 25 carbon atoms.

3. The method of claim 1, wherein the solvent comprises at least one of water, a monohydroxy alcohol, an ether, or a ketone, wherein the monohydroxy alcohol, the ether, and the ketone each independently have up to 4 carbon atoms.

4. The method of claim 1, wherein the fluorinated anionic surfactant is adsorbed on the hydrocarbon-bearing formation.

5-6. (canceled)

7. The method of claim 1, wherein the fluorinated anionic surfactant comprises at least one of —P(O)(OY)₂, —O—P(O)(OY)₂, (—O)₂—P(O)(OY), —SO₃Y, —O—SO₃Y, or —CO₂Y, and wherein Y is hydrogen or a counter cation.

8. The method of claim 1, wherein the surfactant is a polymeric surfactant comprising fluorinated repeating units, and wherein the polymeric surfactant is represented by formula: 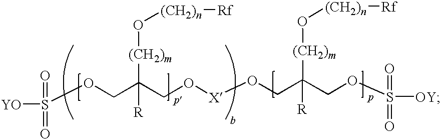
wherein
each Rf is independently perfluoroalkyl having up to 8 carbon atoms;
each R is independently hydrogen, alkyl having 1 to 6 carbon atoms, or —(CH₂)ₘ—O—(CH₂)ₙ-Rf;
each m is independently 1, 2, or 3;
each n is independently 0, 1, 2, or 3;
b is 0 or 1, and when b is 1, p′ has a value from 0 to 5;
p has a value from 0 to 10, with the proviso that p+p′ is at least 2;
X′ is alkylene that is optionally interrupted by —O— or —S—; and
Y is hydrogen or a counter cation.

9. The method of claim 8, wherein each Rf is independently perfluoroalkyl having up to 4 carbon atoms, wherein each R is independently hydrogen or methyl, and wherein m and n are each 1.

10. The method of claim 1, wherein the surfactant is represented by formula:
(Rf²-X—O)ₓ—P(O)—(OY)₃₋ₓ;
(Rf²-X—O)—P(O)—(OY)(O—X″—OH);
Rf²-X—SO₃Y;
Rf²-X—CO₂Y; or
Rf²-X—P(O)(OY)₂;
wherein
Rf² is independently perfluoroalkyl having an average of up to 8 carbon atoms;
X is independently:
a bond;
—SO₂—N(R′)(C_{y}H_{2y})—;
—C(O)—N(R′)(C_{y}H_{2y})—; and
alkylene that is optionally interrupted by —O— or —S—;
X″ is alkylene that is optionally interrupted by —O— or —S— or substituted by hydroxyl;
Y is hydrogen or a counter cation;
x is 1 or 2;
R′ is an alkyl group having up to 4 carbon atoms; and
y is an integer having a value from 1 to 11.

11. The method of claim 10, wherein the surfactant is represented by formula (Rf-X—O)ₓ—P(O)—(OY)₃₋ₓ, wherein X is —CH₂—CH₂—, and wherein Y is an alkylammonium counter cation.

12. The method of claim 1, wherein the hydrocarbon-bearing formation is predominantly sandstone.

13. The method of claim 1, wherein the hydrocarbon-bearing formation comprises at least one of carbonates or limestone.

14. The method of claim 13, wherein the fluorinated anionic surfactant is represented by formula Rf²-SO₃Y″; Rf⁴-CO₂Y″; or 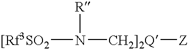
wherein
Rf² is perfluoroalkyl having up to 8 carbon atoms;
Rf⁴ is perfluoroalkyl having up to 6 perfluorinated carbon atoms and interrupted by 1 to 5 ether groups;
Rf³ is a C₂-C₅ perfluoroalkyl group;
R″ is a C₁-C₄ alkyl or aryl group;
Q′ is —CHO—, —CHO(C_{z}H_{2z})—, —CHO(C_{z}H_{2z}O)ₚ(C_{z}H_{2z})—, —CHS—, —CHS(C_{z}H_{2z})—, —CHS(C_{z}H_{2z}O)_{q}(C_{z}H_{2z})— or —CHOC(O)(C_{z}H_{2z})—, in which q is an integer from 1 to 50;
Z is —COOY″, —SO₃Y″, —N(R″)₂—(CH₂)_{z}COOY″, —N⁺(R″)₂(CH₂)_{z}SO₃Y″, —OSO₃Y″, —P(O)(OY″)², or —PO₅³⁻, in which each z is independently an integer of 1 to 10, and
Y″ is hydrogen, a counter cation, or a bond to the hydrocarbon-bearing formation.

15. The method of claim 1, further comprising contacting the hydrocarbon-bearing formation with a fluid prior to contacting the hydrocarbon-bearing formation with the composition, wherein the fluid is substantially free of fluorinated surfactants, wherein the fluid at least one of partially solubilizes or partially displaces the brine in the hydrocarbon-bearing formation, and wherein the fluid comprises at least one of toluene, diesel, heptane, octane, condensate, water, methanol, ethanol, or isopropanol.

16. (canceled)

17. The method of claim 1, wherein the hydrocarbon-bearing formation is penetrated by a wellbore, and wherein a region near the wellbore is contacted with the composition, the method further comprising obtaining hydrocarbons from the wellbore after contacting the hydrocarbon-bearing formation with the composition.

18. (canceled)

19. The method of claim 1, wherein the hydrocarbon-bearing formation has at least one fracture, and wherein the fracture has a plurality of proppants therein.

20. A hydrocarbon-bearing formation having brine treated according to the method of claim 1.

21. A hydrocarbon-bearing siliciclastic formation having brine, wherein the hydrocarbon-bearing siliciclastic formation having brine is a retrograde condensate gas reservoir penetrated by a well bore, and wherein a region near the well bore is treated with a fluorinated anionic surfactant in an amount sufficient to increase gas permeability in the formation.

22. The hydrocarbon-bearing siliciclastic formation of claim 21, wherein the polymeric surfactant is represented by formula: 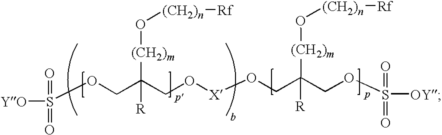
wherein
each Rf is independently perfluoroalkyl having up to 8 carbon atoms;
each R is independently hydrogen, alkyl having 1 to 6 carbon atoms, or —(CH₂)ₘ—O—(CH₂)ₙ-Rf;
each m is independently 1, 2, or 3;
each n is independently 0, 1, 2, or 3;
b is 0 or 1, and when b is 1, p′ has a value from 0 to 5;
p has a value from 0 to 10, with the proviso that p+p′ is at least 2;
X′ is alkylene that is optionally interrupted by —O— or —S—; and
each Y″ is independently hydrogen, a counter cation, or a bond to the hydrocarbon-bearing siliciclastic formation.

23. The hydrocarbon-bearing siliciclastic formation of claim 21, wherein the fluorinated anionic surfactant is represented by formula:
(Rf²-X—O)ₓ—P(O)—(OY″)₃₋ₓ;
(Rf²-X—O)—P(O)—(OY″)(O—X″—OH);
Rf²-X—SO₃Y″;
Rf²-X—CO₂Y″; or
Rf²-X—P(O)(OY″)₂;
wherein
Rf² is independently perfluoroalkyl having an average of up to 8 carbon atoms;
X is independently:
—SO₂—N(R′)(C_{y}H_{2y})—;
—C(O)—N(R′)(C_{y}H_{2y})—; or
alkylene that is optionally interrupted by —O— or —S—;
X″ is alkylene that is optionally interrupted by —O— or —S—;
x is 1 or 2;
R′ is an alkyl group having up to 4 carbon atoms;
Y″ is independently hydrogen, a counter cation, or a bond to the hydrocarbon-bearing siliciclastic formation; and
y is an integer having a value from 1 to 11.

24. The hydrocarbon-bearing siliciclastic formation of claim 23, wherein the fluorinated anionic surfactant is represented by formula (Rf-X—O)ₓ—P(O)—(OY″)₃₋ₓ, wherein X is —CH₂—CH₂—.
